(19) United States
(12) Patent Application Publication
(10) Pub. No.: US 2013/0031476 A1
(43) Pub. Date: Jan. 31, 2013

(54) VOICE ACTIVATED VIRTUAL ASSISTANT

(71) Applicants: Emmett COIN, Canton, MI (US); Deborah Dahl, Plymouth Meeting, PA (US); Richard Mandelbaum, Jamaica, NY (US)

(72) Inventors: Emmett COIN, Canton, MI (US); Deborah Dahl, Plymouth Meeting, PA (US); Richard Mandelbaum, Jamaica, NY (US)

(21) Appl. No.: 13/555,232

(22) Filed: Jul. 23, 2012

Related U.S. Application Data
(60) Provisional application No. 61/511,172, filed on Jul. 25, 2011.

(51) Int. Cl. G06F 3/048

(52) U.S. Cl. 715/706

(57) ABSTRACT

A method and system is presented for providing information to a user interactively using a conversation manager thereby mimicking a live personal assistant. Communication between the user and the system can be implemented orally and/or by using visual cues or other images. The conversation manager relies on a set of functions defining very flexible adaptive scripts. As a session with a user is progressing, the conversation manager, obtains information from the user refining or defining more accurately what information is required by the user. Responses from the user result in the selection of different scripts or subscripts. In the process of obtaining information, data may be collected that is available either locally, from a local sensor, or remotely from other sources. The remote sources are accessed by automatically activating an appropriate function such as a search engine and performing a search over the Internet.

### RELATED APPLICATIONS

This application claims priority to U.S. Provisional Patent Application Ser. No. 61/511,172 filed Jul. 25, 2011, incorporated herein in its entirety.

### BACKGROUND OF THE INVENTION

a. Field of the Invention

The field of the invention pertains to software implemented multimodal dialog systems, which implement interactions between a human being and a computer system based on speech and graphics. In particular, this invention pertains to a system generating multimodal dialogs for a virtual assistant.

b. Background of the Invention

Verbal and multimodal dialog systems have the potential to be extremely useful in the interactions with computers and mobile devices since such interactions are much more natural than the ones using conventional interfaces. Verbal interactions allow users to interact with a computer through a natural speech and touch interface. However, compared to interaction with other people, multimodal interaction with systems is limited and often characterized by errors due to misunderstandings of the underlining software and the ambiguities of human languages. This is further due to the fact that natural human-human interaction is dependent on many factors, including the topic of the interaction, the context of the dialog, the history of previous interactions between the individuals involved in a conversation, as well as many other factors. Current development methodology for these systems is simply not adequate to manage this complexity.

Conventional application development methodology generally follows one of two paradigms. A purely knowledge-based system requires the developer to specify detailed rules that control the human-computer interaction at a low level of detail. An example of such an approach is VoiceXML

VoiceXML has been quite successful in generating simple verbal dialogs, however this approach cannot be extended to mimic even remotely a true human interaction due to the complexity of the programming task, in which each detail of the interaction must be handled explicitly by a programmer. The sophistication of these systems is limited by the fact that it is very difficult to program explicitly every possible contingency in a natural dialog.

The other major paradigm of dialog development is based on statistical methods in which the system learns how to conduct a dialog by using machine learning techniques based on annotations of training dialogs, as discussed, for example, in (Paek & Pieraccini, 2008). However, a machine-learning approach requires a very large amount of training data, which is impractical to obtain in the quantities required to support a complex, natural dialog.

### SUMMARY OF THE INVENTION

The present invention provides a computer implemented software system generating a verbal or graphic dialog with a computer-based device which simulates real human interaction and provides assistance to a user with a particular task.

One technique that has been used successfully in large software projects to manage complexity is object oriented programming, as exemplified by programming languages such as Smalltalk, C++, C#, and Java, among others. This invention applies object oriented programming principles to manage complexity in dialog systems by defining more or less generic behaviors that can be inherited by or mixed in with other dialogs. For example, a generic interaction for setting reminders can be made available for use in other dialogs. This allows the reminder functionality to be used as part of other dialogs on many different topics. Other object oriented dialog development systems have been developed, for example, (O'Neill & McTear, 2000); however, the O'Neill and McTear system requires dialogs to be developed using procedural programming languages, unlike the current invention.

The second technique exploited in this invention to make the development process simpler is declarative definition of dialog interaction. Declarative development allows dialogs to be defined by developers who may not be expert programmers, but who possess spoken dialog interface expertise. Furthermore, the declarative paradigm used in this invention is based on the widely-used XML syntactic format (Bray, Jean Paoli, Sperberg-McQueen, Maler, & Yergeau, 2004) for which a wide variety of processing tools is available. In addition to VoiceXML, other declarative XML-based dialog definition formats have been published, for example, (Li, Li, Chou, & Liu, 2007) (Scansoft, 2004), however, these aren't object-oriented.

Another approach to simplifying spoken system dialog development has been to provide tools to allow developers to specify dialogs in terms of higher-level, more abstract concepts, where the developer's specification is subsequently rendered into lower-level programming instructions for execution. This approach is taken, for example, in (Scholz, Irwin, & Tamri, 2008) and (Norton, Dahl, & Linebarger, 2003). This approach, while simplifying development, does not allow the developer the flexibility that is provided the current invention, in which the developer directly specifies the dialog.

The system's actions are driven by declaratively defined forward chaining pattern-action rules, also known as production rules. The dialog engine uses these production rules to progress through a dialog using a declarative pattern language that takes into account spoken, GUI and other inputs from the user to determine the next step in the dialog.

The system is able to vary its utterances, based on the context of the dialog, the user's experience, or randomly, to provide variety in the interaction.

The system possesses a structured memory for persistent storage of global variables and structures, similar to the memory used in the Darpa Communicator system (Bayer & al., 2001) but making use of a structured format.

The system is able to interrupt an ongoing task and inject a system-initiated dialog, for example, if the user had previously asked to be reminded of something at a particular time or location.

### BRIEF DESCRIPTION OF THE DRAWINGS

FIG. 1 shows a block diagram of a conversation manager constructed in accordance with this invention;

FIG. 2 shows a flow chart of a standard communication between the system and a client/user and the resulting exchange of messages therebetween;

FIG. 3 shows a flow chart of the conversation loop process;

FIG. 4 shows a flow chart for evaluation input signals for various events;

FIG. 5 shows a flow chart for the evaluation rules;

FIG. 6 shows a flow chart for the process rule;

FIG. 7 shows a flow chart for selecting a STEP file;

FIG. 8 shows a flow chart for the introduction section;

FIG. 9 shows a flow chart for the presentation adaptation;

FIG. 10 shows a flow chart for assembling the presentation and attention messages;

FIG. 11 shows a flow chart for processing string objects;

FIG. 12 shows a flow chart for processing time-relevant events;

FIG. 13 shows a flow chart for updating grammars;

401, 1402, 1403 . . . .

FIGS. 14A-14L shows a flow chart illustrating how a grocery shopping list is generated in accordance with this invention using the processes of FIGS. 2-12; and

FIG. 15A-15S shows a flow chart illustrating buying a pair of ladies shoes using the processes of FIGS. 2-12.

### DETAILED DESCRIPTION OF THE INVENTION

### a. Definitions

The following terminology is used in the present application:

Multimodal Dialog System: A dialog system wherein the user can choose to interact with the system in multiple modalities, for example speech, typing, or touch.

Conversation Manager: A system component that coordinate the interaction between the system and the user. Its central task is deciding what the next steps in the conversation should be based on the user's input and other contextual information.

Conversational Agent: A synthetic character that interacts with the user to perform activities in a conversational manner, using natural language and dialog.

Pervasive application: An application that is continually available no matter what the user's location is.

Step file: A declarative XML representation of a dialog used in the conversation manager system.

### b. General Description:

The system is built on a conversation manager, which coordinates all of the input and output modalities including speech I/O, GUI I/O, Avatar rendering and lip sync. The conversation manager also marshals external backend functions as well as a persistent memory which is used for short and long term memory as well as application knowledge.

In the embodiment shown in the figures, it is contemplated that the system for generating a dialog is a remote system accessible to a user remotely through the Internet. Of course, the system may also be implemented locally on a user device (e.g., PC, laptop, tablet, smartphone, etc.)

The system 100 is composed of the following parts:

1. Conversation Manager 10: The component that orchestrates and coordinates the dialog between the human and the machine.

2. Speech I/O 20: This system encapsulates speech recognition and pre- and post-processing of data involved in that recognition as well as the synthesis of the agent's voice.

3. Browser GUI 30: This displays information from the conversation manager in a graphic browser context. It also supports the human's interaction with the displayed data via inputs from the keyboard, mouse and touchscreen.

4. Avatar 40: This is a server/engine that renders a 3-D image of the avatar/agent and lip-synched speech. It also manages the performance of gestures (blinking, smiling, etc.) as well as dynamic emotional levels (happy, pensive, etc.). The avatar is based can be based on the Haptek engine, available from the Haptek corporation located atHaptek, Inc., P.O. Box 965, Freedom, Calif. 95019-0965, USA. The technical literature clearly supports that seeing a speaking face improves perception of speech over speech provided through the audio channel only (Massaro, Cohen, Beskow, & Cole, 2000; Sumby & Pollack, 1956). In addition, research by (Kwon, Gilbert, & Chattaraman, 2010) in an e-commerce application has shown that the use of an avatar on an e-commerce website makes it more likely that older website users will buy something or otherwise take advantage of whatever the website offers.

5. Conversation definition 50: The manager 10 itself has no inherent capability to converse. But rather it is an engine that interprets a set of definition files. One of the most important definition file types is the STEP file (defined above). This file represents a high-level limited domain representation of the path that the dialog should take.

6. Persistent memory 60: The conversation manager maintains a persistent memory. This is a place for application related data, external function parameters and results. It also provides a range of “autonomic” functions that track and manage a historical record of the previous experiences between the agent and the human.

7. External functions 70: These are functions callable directly from the conversation flow as defined in the STEP files. They are real routines/programs written in existing computer and/or web-based languages (as opposed to internal conversation manager scripting or declaration statements) that can access data in normal programmatic ways such as files, the Internet, etc. and can provide results to the engine's persistent memory that are immediately accessible to the conversation. The STEP files define a plurality of adaptive scripts used to guide the conversation engine 10 through a particular scenario. As shall become apparent from the more detailed descriptions below, the scripts are adaptive in the sense that during each encounter or session with an user, a script is followed to determine what actions should be taken, based on responses from the user and/or other information. More specifically, at a particular instances, a script may require the conversation engine 10 to take any one of several actions including, for instance “talking” to the user to obtain one or more new inputs, initiating another script or subscript, obtain some information locally available to conversation manager 10, (e.g., current date and time), obtain a current local parameter (e.g., current temperature), initiate an external function automatically to obtain information from other external sources (e.g., initiating a search using a browser to send requests and obtain corresponding information over the Internet), etc.

Next we consider these components in more detail.

The Conversation Engine 10

The central hub of the system is the conversation manager or engine 10. It communicates with the other major components via XML (either through direct programmatic links or through socket-based communication protocols). At the highest level, the manager 10 interprets STEP files which define simple state machine transitions that embody the “happy path” for an anticipated conversation. Of course the “happy path” is only an ideal. That is where the other strategies of the manager 10 come to bear. The next level of representation allows the well-defined “happy path” dialogs to be derived from other potential dialog behaviors. The value of this object-oriented approach to dialog management has also been shown in previous work, such as (Hanna, O′neill, Wootton, & Mctear, 2007). Using an object-oriented approach it is possible to handle “off focus” patterns of behavior by following the STEP derivation paths. This permits the engine to incorporate base behaviors without the need to weave all potential cases into every point in the dialog. These derivations are multiple and arbitrarily deep as well. This facility supports simple isolated behaviors such as “thank you” interactions, but also more powerfully, it permits related domains to be logically close to each other so that movement between them can be more natural.

Typically, any of the components (e.g., Audio I/O, 20 Browser GUI 30, and Avatar 40) can be used to interact with the user. In our system, all three maybe used to create a richer experience and to increase communicative effectiveness through redundancy. Of course not all three components are necessary.

The Audio Audio I/O Component 20:

The conversation manager 10 considers the speech recognition and speech synthesis components to be a bundled service that communicates with the conversation engine via conventional protocols such as programmatic XML exchange. In our system, the conversation manager 10 instructs the speech I/O module 20 to load a main grammar that contains all the rules that are necessary for a conversation. It is essential that the system 100 recognize utterances that are off-topic and that have relevance in some other domain. In order to do this the grammar includes rules for a variety of utterances that may be spoken in the application, but are not directly relevant to the specific domain of the application. Note that the conversation manager 10 does not directly interface to any specific automatic speech recognition (ASR) or text-to-speech (TTS) component. Nor does it imply any particular method by which the speech I/O module interprets the speech via the Speech Recognition Grammar Specification (SRGS) grammars (Hunt & McGlashan, 2004).

The conversation engine 10 delegates the active listening to the speech I/O subsystem and waits for the speech I/O to return when something was spoken. The engine expects the utterance transcription as well as metadata such as rules fired and semantic values along with durations, energies, confidence scores etc. and all of this is returned in an XML structure by the conversation engine. An example of such an XML structure is the EMMA (Extensible Multimodal Annotation) standard. In addition, and in the case where the Avatar is not handling the speech output component (or not even present), the speech I/O module synthesizes what the conversation manager has decided to say.

Browser GUI 30

The conversation manager includes an HTML server. It is an integral part of the engine and it is managed via STEP file definitions. This allows the conversation manager to dynamically display HTML. This is accomplished via AJAX (Asynchronous JavaScript+XML) methodology which is used to dynamically update web pages without having to reload the entire page₊ and inserts “inner HTML” into an HTML page that is hosted by the internal HTML server. Additionally, keyboard, mouse, and screen touch actions can be associated with individual parts of the dynamically displayed HTML page that enable acts of “clicking” or “typing” in a text box to generate unique identifiable inputs for the conversation manager 10 in the conventional manner. Note these inputs into the manager are treated much the same way as spoken input. All the modalities of input are dealt with at the same point in the conversation engine 10 and are considered as equal semantic inputs. The conversation engine 10 engages all the modalities equally and this makes acts of blended modalities very easy to support.

The Avatar Engine

The Avatar engine 40 is an optional stand-alone engine that renders a 3-D model of an avatar head. In the case of the Haptek engine based Avatar the head can be designed with a 3D modeling tool and saved in a specific Haptek file format that can then be selected by the conversation manager and the declarative conversation specification files and loaded into the Haptek engine at runtime. If a different Avatar engine were used it may or may not have this Avatar design capability. Selecting the Avatar is supported by the conversation manager regardless, but clearly it will not select a different Avatar if the Avatar engine does not support that feature. When the Avatar engine is active, spoken output from the conversation manager 10 is directed to the Avatar directly and not to the speech I/O module. This is because tight coupling is required between the speech synthesis and the visemes that must be rendered in sync with the synthesized voice. The Avatar 40 preferably receives an XML structured command from the conversation manager 10 which contains what to speak, any gestures that are to be performed (look to the right, smile, etc.), and the underlying emotional base. That emotional base can be thought of as a very high level direction given to an actor (“you're feeling skeptical now,” “be calm and disinterested”) based on content. The overall emotional state of the Avatar is a parameter assigned to the Avatar by the conversation manager in combination with the declarative specification files. This emotional state augments the human user's experience by displaying expressions that are consistent with the conversation manager's understanding of the conversation at that point. For example, if the conversation manager has a low level of confidence in what the human was saying (based on speech recognition, semantic analysis, etc.) then the Avatar may display a “puzzled” expression. It is achieved with a stochastic process across a large number of micro-actions that makes it appear natural and not “looped.”

Dialog Definitions 50

Dialog definitions are preferably stored in a memory, preferably as a set of files that define the details of what the system 100 does and what it can react to. There are several types of files that define the conversational behavior. The recognition grammar is one of these files and is integral to the dialog since the STEP files can refer directly to rules that were initiated and/or semantics that were set. Each STEP file represents a simple two turn exchange between the agent and the user (normally turn 1: representing an oral statement from the system and turn 2: a response from the human user). In its simplest form, the STEP file begins with something to say upon entry and then it waits for some sort of input from the user which could be spoken or “clicked” on the browser display or other modalities that the conversation engine is prepared to receive. And finally a collection of rules that define patterns of user input and/or other information stored in the persistent memory 60. When speech or other input has been received by the engine, then the rules in the STEP with conversational focus are examined to see if any of them match one of several predetermined patterns or scenarios. If not, the system follows a derivation tree as discussed more fully below. One or more STEP files can be derived from other STEP files. The conversation manager loops through the rules in those “base” STEP files from which it is derived. Since the STEP files can be derived to any arbitrary depth the overall algorithm is to search the STEP files in a “depth first recursive decent” and as each STEP file is encountered in this “recursion” the rules are evaluated in the order that they appear in the STEP file for a more generic rule that might If it finds a match then it executes its associated actions. If nothing matches through all the derivation then no action is taken. It is as if the agent heard nothing.

The STEP also controls other aspects of the conversation. For example it can control the amount of variability in spoken responses by invoking generative grammars (production SRGS grammar files). Additionally the conversation manager 10 is sensitive to the amount of exposure the user has had at any conversational state and can react to it appropriately. For example, based on whether the user has never been to a specific section of the conversation, the engine can automatically prompt with the needed explanation to guide the user through, but if the user has done this particular thing often and recently then the engine can automatically generate a more direct and efficient prompt and present the conversational ellipsis that a human would normally provide. This happens over a range of exposure levels. For example, if the human asked “What is today's date? (or something that had the same semantic as “tell me the date for today”) then upon the first occurrence of this request the conversation manager might respond with something like “Today is July 4^{th} 2012”. If the human asked again a little later (the amount of time is definable in the STEP files) then the system might respond with something like “The 4^{th} of July”. And if the human asked again the system might just say “The 4^{th}”. This is done automatically based on the how recently and frequently this semantically equivalent request is made. It is not necessary to specify those different behaviors explicitly in the overall flow of the conversation. This models what the way human-human conversations compress utterances based on a reasonable assumption of shared context. Note that in the previous example that if the human asked for the date after a long period that the system would revert back to more verbose answers much like a human conversational partner would since the context is less likely to remain constant after longer periods of time. Additionally, these behaviors can be used in an opposite sense. The same mechanism that allows the conversation manager's response to become more concise (and efficient) can also be used to become more expansive and explanatory. For example, if the human were adding items to a list and they repeatedly said things like “I need to add apples to my shopping list” then the conversation manager could detect that this type of utterance is being used repeatedly in a tight looping process. Since the context of “adding something to my shopping list” is a reasonable context for this context the STEP file designer could choose to advise the human that “Remember that if you are adding a number of things to the same list then I will understand the context. So once I know that we are adding to your shopping list you only need to say—Add apples—and I will understand.” In addition to helping the human explicitly the conversation manager has all the while been using conversational ellipsis in its responses by saying “I added apples to your shopping list”, “I added pears to the list”, “added peaches”, “grapes”. This is likely to cue the human automatically to follow suit and shorten their responses in the way we all do in human-human conversations.

When displaying simple bits of information (e.g. a line of text, an image, a button, etc.) in the browser context the conversation manager can transmit small snippets of XHTML code (XHTML is the XML compliant version of HTML) that are embedded directly into the STEP file declarations. These are included directly inside the <displayHTML> element tags in the STEP file. When displaying more complex sections of XHTML such as lists or tables then another type of declarative file is used to define how a list of records (in the conversation manager's persistent memory will be transformed into the appropriate XHTML before it is transmitted to the browser context. The display format files associate the raw XML data on the persistent memory with corresponding XHTML elements and CSS (Cascading Style Sheets) styles for those elements. These generated XHTML snippets are automatically instrumented with various selectable behaviors. For example a click/touch behavior could be automatically assigned to every food item name in a list so that the display would report to the conversation manager which item was selected. Other format controls include but are not limited to table titles, column headings, automatic numbering, alternate line highlighting, etc.

External Functions 70

These functions perform automatically the actual retrieving, modifying, updating, converting, etc. the information for the conversational system. The conversation definition (i.e., STEP files) is focused purely on the conversational components of the human-computer encounter. Once the engine has determined the intent of the dialog, the conversation manager 10 can delegate specific actions to an appropriate programmatic function. Data from the persistent memory, or blackboard, (Erman, Hayes-Roth, Lesser, & Reddy, 1980) along with the function name, are marshaled in an XML-Socket exchange to the designated Application Function Server (AFS). The AFS completes the requested function and returns an XML-Socket exchange with a status value that is used to guide the dialog (e.g. “found_item” or “item_missing”) as well as any other detailed information to be written to the blackboard. In this way the task of application development is neatly divided into linguistic and programming components. The design contract between the two is a simple statement of the part of the blackboard to “show” to the function, what the function does, what status is expected, and where any additional returned information should be written on the blackboard.

Persistent Memory 60

The conversation manager 19 is associated with a persistent memory 60, or blackboard. Preferably, this memory 60 is organized appears as a very large XML tree. The elements and/or subtrees can be identified with simple path strings. Throughout a given conversation, the manager 10 writes and reads to-and-from the memory 10 for internal purposes such as parses, event lists, state recency, state specific experience, etc. Additionally the conversation can write and read data to-and-from the memory 60. Some of these application elements are atomic, such as remembering that the user's favorite color was “red.” Some other parts that manage the conversational automaticity surrounding lists will read and write things that allow it to remember what row and field had the focus last. Other parts manage the experience level between the human and the system at each state visited in the conversation. It records the experience at any particular point in the conversation and it also permits those experiences to fade in a natural way.

Importantly, memory 60 maintains information about conversations for more than just the session so that the system's adaptive with respect to interactions with the user.

Error! Reference source not found. represents the components of the preferred embodiment of the invention. User interaction modalities are at the top of the diagram. The user can speak to the system and listen to its replies as well through one or more microphones and speakers 80 and/or touch or click a display screen, or the keyboard, the latter elements being designated by 90. All of those interactions are sensed by the corresponding conventional hardware (not shown).

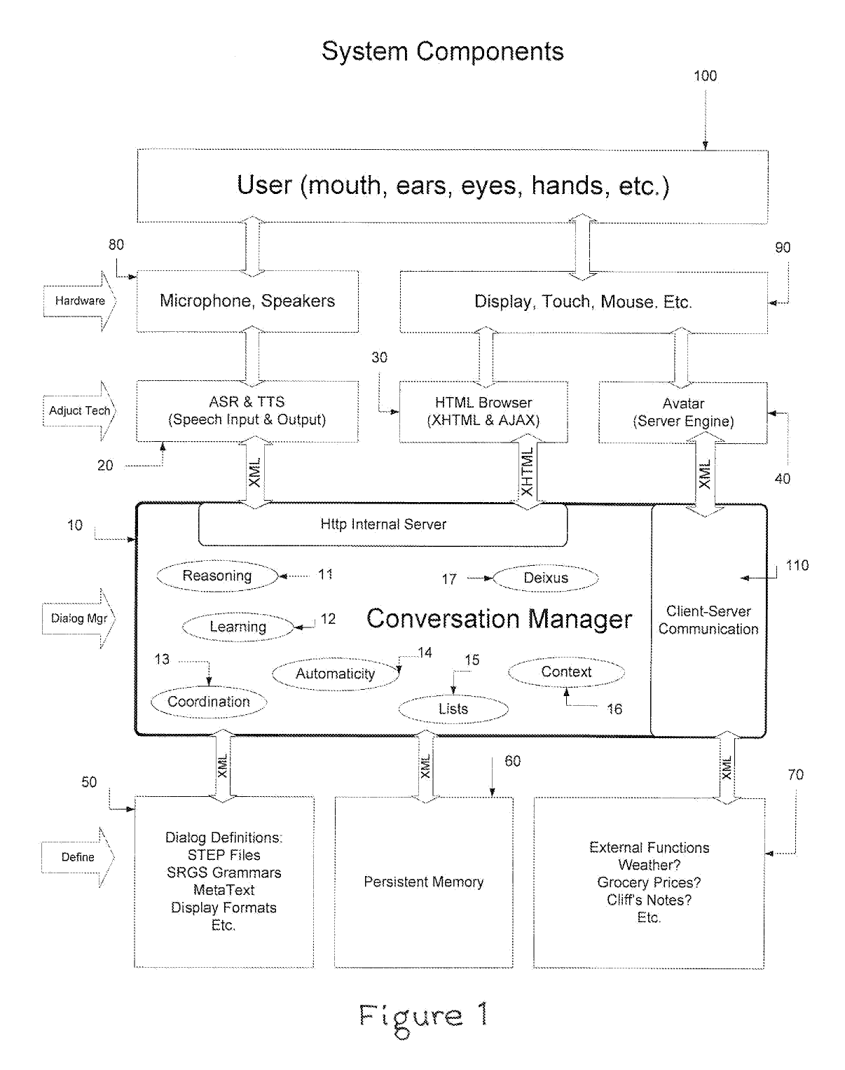

An adjunct tech layer 95 represents various self-contained functionality in software systems that translate between the hardware layer and the conversation manager 10. These may include a number of components or interfaces available from third parties. The conversation manager is encapsulated in that it communicates solely with the outside world via a single protocol such as XML exchanges and anything it knows or records is structured as XML in its persistent memory 60. The system behavior is defined by STEP files (as well as grammars, display formats and other files). These are also XML files. External functions 70 communicate with the conversation manager 10 via a simple XML-based API. These external functions are evoked or initiated by rules associated with some of the STEP files. Optional developer activity 98 is at the bottom of FIG. 1 and represents standard XML editing tools and conventional programming Integrated development environments (IDE's) (for the external functions) as well as specialized debugging and evaluation tools specific to the system.

Declarative Files Used by the Dialog Engine

The conversation manager 10 described above is the central component that makes this kind of a dialog possible. For actual scenarios, it must be supplied with domain-specific information. This includes:

1. The STEP file(s) that define the pattern-action rules the dialog manager follows in conducting the dialog.

2. Speech recognition grammar(s) written in a modified version of the SRGS format (Hunt & McGlashan, 2004) and stored as part of the definitions 50.

3. The memory 60 that contains the system's memory from session to session, including such things as the user's shopping list.

4. Some applications may need non-conversation-related functions, referred to earlier as AFS functions. An example of this might be a voice-operated calculator. This kind of functionality can be supplied by an external server that communicates with the dialog engine 10 over sockets 110.

5. A basic HTML file that defines the graphical layout of the GUI display and is updated by the conversation engine using AJAX calls as needed.

Each STEP file stored as part of the dialog definitions 50 includes certain specific components defined in accordance with certain rules as mandated by respective scenarios. In the following exemplary description, the STEP file for a shopping list management is described.

Description of the Major Components of the Step File for a Shopping List Management

The respective STEP file consists of an administrative section <head> and a functional section <body> much like an HTML page. An important part of the <head> section is the <derivedFrom> element which points to a lineage of other STEP files from which this particular STEP file “inherits” behaviors (this inheritance is key to the depth and richness of the interactions that can be defined by the present invention). The <body> section represents two “turns” beginning with the <say> element which defines what the system (or its “agent”) says, gestures and emotes. This is followed by a <listen> section which can be used to restrict what the agent listens for, but in very open dialog such as this one, the “listen” is across a larger grammar to allow freer movement between domains. The last major component of the <body> is the <response> section and it is where most of the mechanics of the conversation take place. This section contains an arbitrary number of rules each of which may have an arbitrary number of cases. The default behavior is for a rule to match a pattern in the text recognized from the human's utterance. In actual practice, the source string to be tested as well as the pattern to be matched, can be complex constructs assembled from things that the conversation engine knows—things that are in its persistent memory 60. If a rule is triggered, then the corresponding actions are executed. Usually this involves calling one or more internal or external functions, generating something to “say” to the human, and presenting some visual elements for multimodal display. Note that the input pattern for a “rule” is not limited to speech events and rules can be based on any input modality that the engine is aware of. In this application the engine is aware of screen touches, gestures, mouse and keyboard interaction in addition to speech.

```
        <step>
          <name>groceryListDomain</name>
          <head>
            <purpose>Manage a Grocery List</purpose>
            <derivedFrom>niBase.XML</derivedFrom>
            <author>Emmett Coin</author>
            <date>20100221</date>
          </head>
          <body>
            <say>
              <text>Cool! Let's work on your grocery list.</text>
            </say>
            <listen>
            </listen>
            <response>
              <rule name=“show”>
                <pattern input=“{R:ejShowCMD:ejExist},
                {S:ejListCategory:}”>
                  TRUE,ejGroceryList
                </pattern>
                <examplePattern>
                  <ex>show my shopping list</ex>
                </examplePattern>
                <action>
                  <function>
                    <AFS function=“list.display”>
                      <paramNode>
<listFormatName>shoppingListFormat1.XML</listFormatName>
                        <dataLocation>grocery/currentList
                        </dataLocation>
                      </paramNode>
                      <resultNode>grocery</resultNode>
                    </AFS>
                  </function>
                  <presay>
                    <text>Here's the shopping list.|</text>
                  </presay>
                  <displayHTML>
                    <information type=“treeReference”>
                      grocery/display/form/div
                    </information>
                    <ejSemanticFeedback>Show my shopping
list.</ejSemanticFeedback>
          </displayHTML>
        </action>
          <goto>groceryListDomain.XML</goto>
          </rule>
        <!-- in the full STEP there are many more rules to service: -->
        <!-- deixis, deletion, verifying, etc. -->
          </response>
        </body>
        </step>
```

The following example illustrates the concept of inheritance of basic conversation capabilities that are inherited by other more specific dialogs. This inherited STEP supports a user request for the system to “take a break,” and is available from almost every other dialog. Notice that even this STEP is derived from other basic STEPS.

```
        <step>
          <name>ejBase</name>
          <head>
            <objectName>CassandraBase</objectName>
            <purpose>Foundation for all application STEP objects</purpose>
            <version>3.05</version>
<derivedFrom>ejTimeBase.XML|reminderListDomain.XML</derivedFrom>
            <author>Emmett Coin</author>
            <date>20090610</date>
          </head>
          <body>
            <listen>
              <grammar>ejBase</grammar>
            </listen>
            <response>
              <rule name=“baseCommand”>
                <pattern>[W:command] CASSANDRA</pattern>
                <examplePattern>
                  <ex>Take a break Cassandra</ex>
                </examplePattern>
                <action>
                  <function>
                    <AFS server=“INTERNAL” function=“agent.command”>
                      <paramNode>system/asr/vars</paramNode>
                    <resultNode>system/program/request</resultNode>
                    </AFS>
                  </function>
                </action>
                <branch>
                  <!-- other case sections service Help, log off, louder, softer, etc.
behaviors -->
                  <case id=“*BREAK*|*HOLD*|*WAIT*”>
                    <action>
                      <presay>
                        <text emotion=“ejSkeptic”>Okay, I'll take a break. To wake me
up, say “Cassandra, let's continue.” </text>
                      </presay>
                    </action>
                    <call>ejOnBreak.XML</call>
                  </case>
                  <!-- other case sections service Help, log off, louder, softer, etc.
behaviors -->
                </branch>
              </rule>
            </response>
          </body>
        </step>
```

Memory

A wide variety of information is represented on the memory, including dynamic, user-specific information such as a user's grocery list. In this example the <currentList> node has a number of attributes that are automatically maintained by the conversation manager to keep track of context.

```
    <currentList open=“TRUE” format=“shoppingListFormat1.XML”
lastIndex=“8” listName=“grocery1” dataPath=“grocery/currentList”
rowFocus=“3” fieldFocus=“GROCERY” focusRecord=“4”
focusPath=“description” focusValue=“milk” pathClicked=“units”>
        <item>
          <description>green beans</description>
          <ejTUID>1</ejTUID>
          </item>
        <item>
          <description>cream</description>
          <ejTUID>2</ejTUID>
        </item>
        <item>
          <description>milk</description>
          <ejTUID>3</ejTUID>
        </item>
        </currentList>
```

Other XML Files

Other XML files are used to configure other aspects of the dialog engine's behavior.

Settings

The settings file provides general system configuration information. For example, the following excerpt from a settings file shows information for configuring system logs.

```
<logs>
    <xmlTranscript>TRUE</xmlTranscript>
    <step>
      <directory>logs/</directory>
      <mode>FULL</mode>
      <soundAction>mouseOver</soundAction>
    </step>
    <wave>
      <directory>waves/</directory>
      <mode>FULL</mode>
    </wave>
  </logs>
```

Display Format

The display format files are used to provide styling information to the engine for the HTML that it generates. For example, the following display format file describes a shopping list.

```
        <listFormat name=“shoppingListFormat1”>
          <tableTitle>Grocery List</tableTitle>
          <tableFormat>ejTable2</tableFormat>
          <primaryValue>description</primaryValue>
          <rowFocusClass>ejTableRowFocus</rowFocusClass>
          <rowIndexClass>ejTableIndex</rowIndexClass>
          <fieldFocusClass>ejTableFieldFocus</fieldFocusClass>
          <imageFileLocation relative=“TRUE”>images/
          </imageFileLocation>
          <dbFile relative=“TRUE” type=“XML”>fullGrocery.db.xml
          </dbFile>
          <record node=“item” showColumnTitles=“TRUE”
numberRows=“TRUE”>
            <field title=“Picture” edit=“FALSE”>
              <data>image</data>
              <format>ejImage</format>
            </field>
            <field title=“Grocery” edit=“TRUE”>
              <data>description</data>
              <format>ejText</format>
              <displayClass>ejNormal</displayClass>
            </field>
            <field title=“Amount” edit=“TRUE”>
              <data>quantity</data>
              <format>ejText</format>
            </field>
            <field title=“Category” edit=“TRUE”>
              <data>category</data>
              <format>ejText</format>
            </field>
          </record>
        </listFormat>
```

Meta-Text

Meta-Text files are used to provide different versions of prompts depending on the user's experience with the system. The following fragment shows introductory (“int”), tutorial (“tut”), beginner (“beg”), normal (“nor”) and expert (“exp”) versions of a prompt that means “do you want to”, used to build system utterances like “Do you want to log off”.

```
<doYouWantTo>
    <val>Do you really want to</val>
  <int>
    <val>Just to be sure, do you really intend to</val>
  </int>
  <tut>
    <val>To avoid accidents I will ask this: Do you want to</val>
  </tut>
  <beg>
    <val>Did you say you want to</val>
  </beg>
  <nor>
    <val>Do you want to</val>
  </nor>
  <exp>
    <val>Want to</val>
  </exp>
</doYouWantTo>
```

Production Grammar

The production grammar is used to randomly generate semantically equivalent system responses in order to provide variety in the system's output. The following example shows different ways of saying “yes”, using the standard SRGS grammar format (Hunt & McGlashan, 2004).

```
<rule id=“yes” scope=“public”>
    <one-of>
      <item>yes</item>
      <item>sure</item>
      <item>okay</item>
      <item>certainly</item>
      <item>right</item>
  </one-of>
</rule>
```

Integrating Speech Recognition with Customer Vocabulary

Users will all have a wide variety of product names and types of products which end users will talk about as they shop. In order for a speech recognizer to recognize speech that includes these customer-specific words they will need to be in the speech recognizer's vocabulary. Traditionally, the process of adding vocabulary items to a recognizer is a largely manual task, but a manual process clearly does not scale well as the number of customers and vocabularies increases. In addition, the vocabularies must be continuously maintained as new products are added and old products are removed. We will automate the process of maintaining speech vocabularies by reformatting structured data feeds from our customers into the format that speech recognizers use to configure their vocabularies (grammars). For example, the customer's data feed might include XML data like “<product_type>camera</product_type>”. Our grammar generation tool will use this information to add the word “camera” to the recognizer's grammar or this customer.

Operation of the System

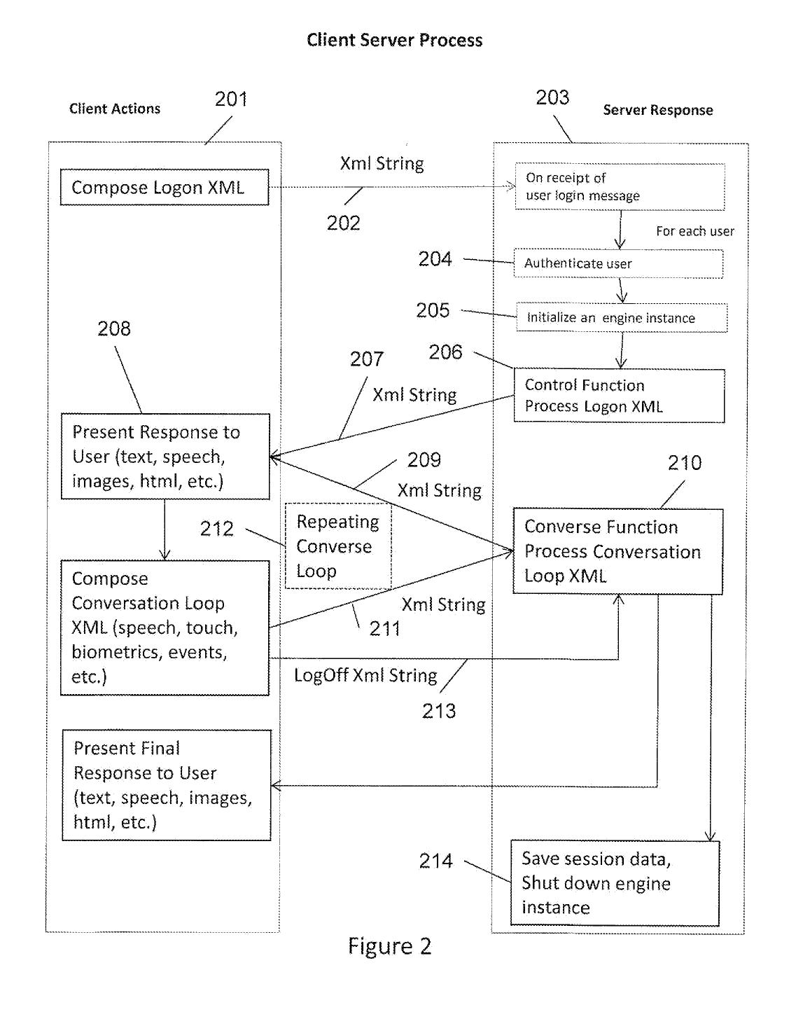

FIG. 2 shows in general terms the operation of the system.

This figure describes the overall communication scheme between the client (201) where the human user experiences the conversation and the server (203) where the conversation is processed.

The process begins with the server running and waiting for the client to send a composed logon message (202). In this figure we referred to it as an XML string but it can be any structured data exchange such as JSON, comma separated values, or other nomenclatures that convey the logon information. Upon receipt of this logon message the server does an appropriate level of authentication (204) based on the requirements of a particular application. If the authentication fails then nothing happens on the server and it just waits for a valid authentication from a valid user. If the authentication is valid then the server initializes a dedicated engine instance for this user (205). In the process of initialization the engine uses user specific information to load previous conversational information as well as to set up an initialize various elements of the application to support the beginning of a new conversation. This initialization includes but is not limited to step files containing prompts and rules, metatext and production grammar specifications that manage this particular user's variability, auxiliary scripts, NLP processing rules, agent characteristics (voices, avatars, persona, etc.), and all other such specifications and controls.

Once initialized the engine along with all of the previously mentioned specification and control files prepares for the first conversational exchange (206) between the system and the human user. This preparation includes preparing displays to be transmitted to the client as well as text, synthesized speech, images, sounds, videos etc. to be presented to the user. All of this information is transmitted (207) to the client in a structured format which is referenced in this figure as an XML string but as mentioned previously can be any form of structured data exchange suitable for a communication network of any sort.

The client receives the structured message and parses out the individual components such as text display, HTML displays, speech synthesis, video and/or audio presentation, etc. the client deals with each of these presentation modalities and presents to the human user the corresponding visuals, text, synthesized speech output, etc. (208)

In addition the client parses any specific commands directed at the client. For example the engine may in the course of its conversation requests that the client provide a geolocation report, or to do a voice verification of the user, or sense the orientation of the client device using the accelerometer, or take a picture with the device's camera, etc. the list of possible commands that the conversation engine can request of the client is only limited by the functions that the client can perform. For example if the client were a telepresence robot, then in addition to all of the previous we mentioned commands there would be a full range of commands to articulate robot appendages, to move and reorient the robot, which operate tools that may be associated with the robot.

After the client has received and processed all of the directives contained in the structured message it waits for some activity on the client side that represents a conversational turn from the human associated with the client device or a report which was the result of a command sent to the client. For instance if the human speaks and the client detects and processes that speech, then the speech recognition result represents a response that the client assembles into a structured message of the kind mentioned above. Some of the things that can be used as a response include but are not limited to speech input, typed input, multimodal and tactile input, sensor events like geolocation or temperature or instrument readings, facial recognition, voice verification, emotion detection, etc.

Once the response has been processed and put into a structured message form it is returned to the conversation engine on the server (209). When the conversation engine receives the structured response message and parses it and decides what to do with each component of the response (210). After processing and evaluating all of the client response in conjunction with the experiential history shared between the engine and the human and after adapting to any current contextual information the engine constructs a structured message similar in form to the first message sent to the client but different in substance in that it will instruct the client what to say, do, display, etc. for the next turn (211). Note: a much more detailed description of what the conversation engine does is described in subsequent figures but for the purpose of this figure it accepts a response and calculates what it should do for the engine's next turn.

This exchange of structured messages between the server and the client continues as long as the conversation continues (212). In addition to responding to the client messages the conversation engine on the server automatically collects and persistently stores a wide range of information relevant to this conversation. That information is merged with information from previous conversations and persists indefinitely. Some of the information that is stored include but is not limited to topics discussed, list items referenced, images viewed, levels of expertise at various points in the conversation, times and places when any of the previous things happened, etc.

When any particular conversational encounter ends, either initiated by the human or the conversation engine, the engine can manage a graceful “goodbye” scenario (213). And as a final action it commits any new information and new perceptions of the user into a permanent data storage format (214). While the system currently uses an XML representation for data storage it is not limited to XML and could use any conventional data storage methodology such as SQL databases, or specifically designed file based storage, or any data storage methodology that might be invented in the future. (Go through the numbered drawings, describing each step in processing).

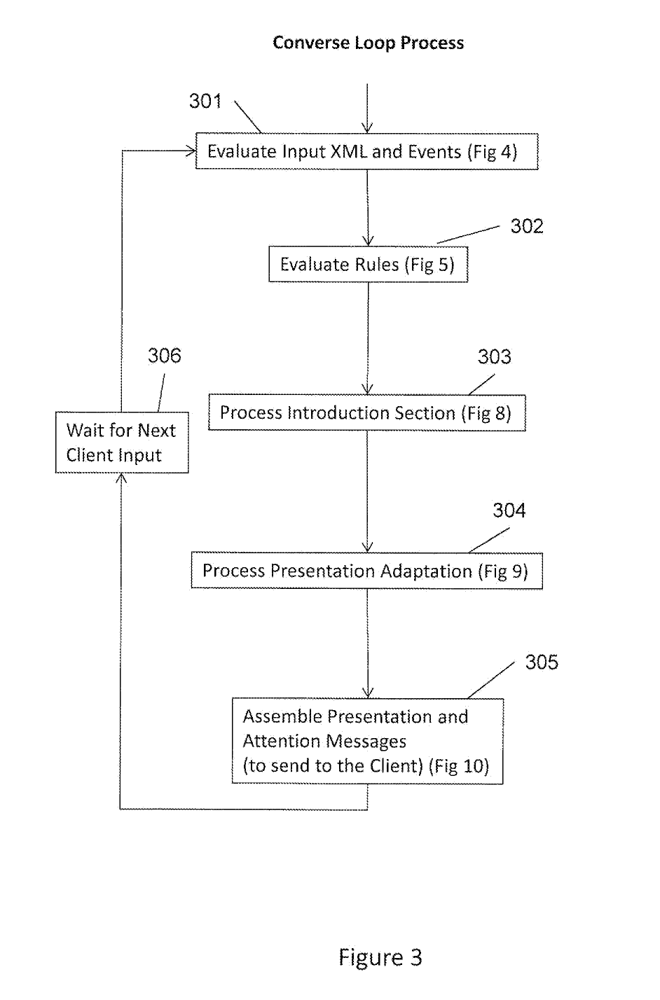

FIG. 3 shows details of the conversation loop process

This figure represents the next level of refinement and understanding the conversation loop process described in FIG. 2.

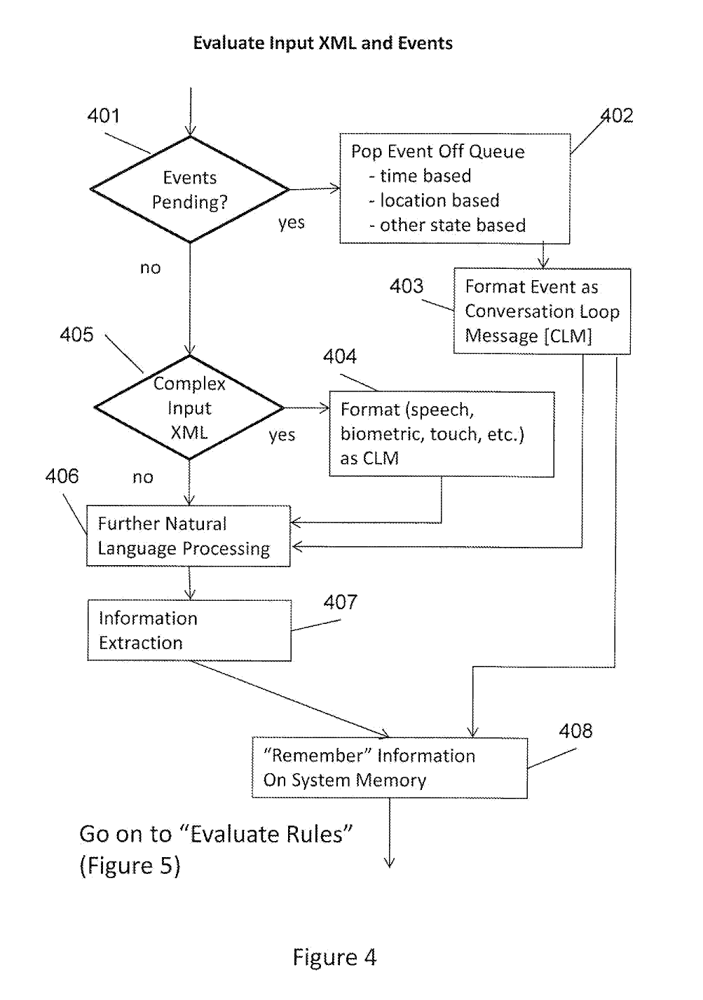

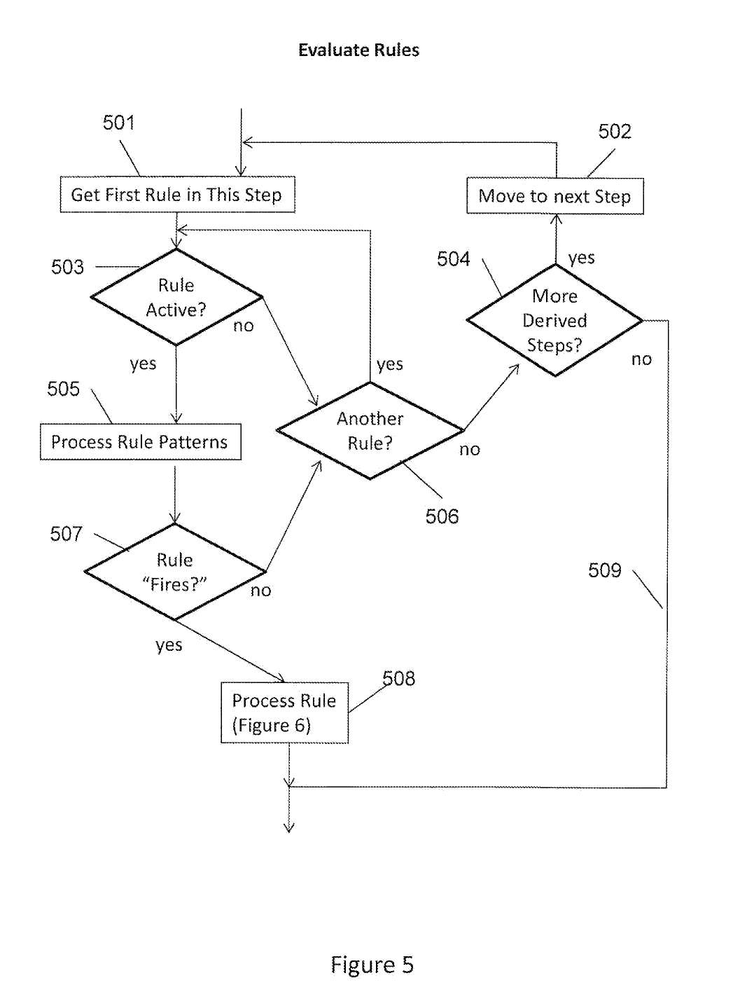

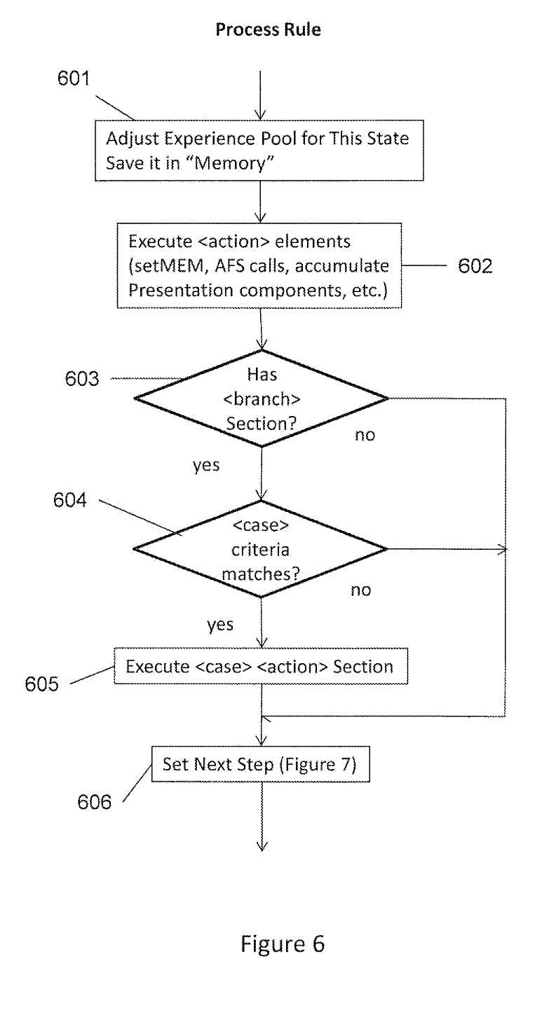

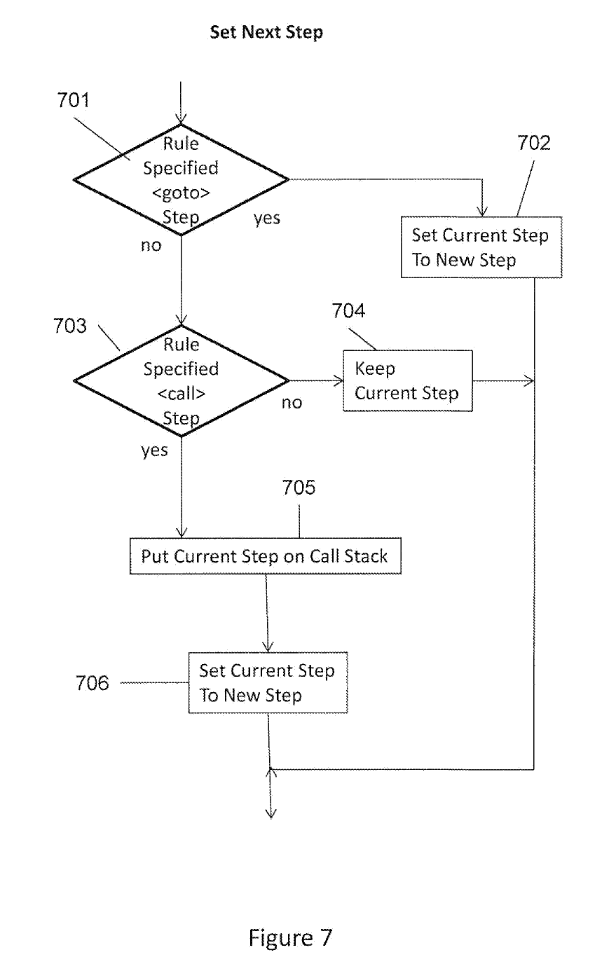

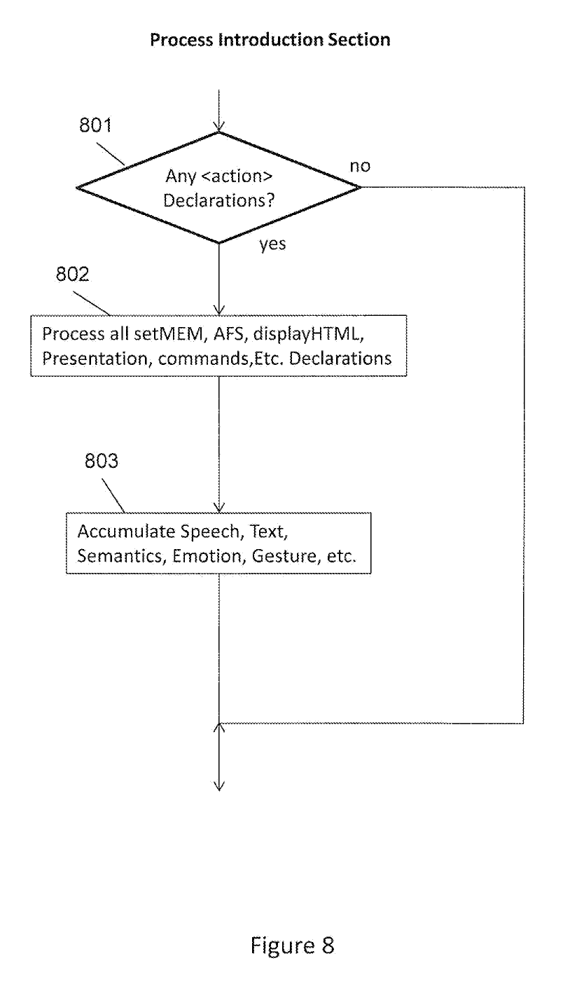

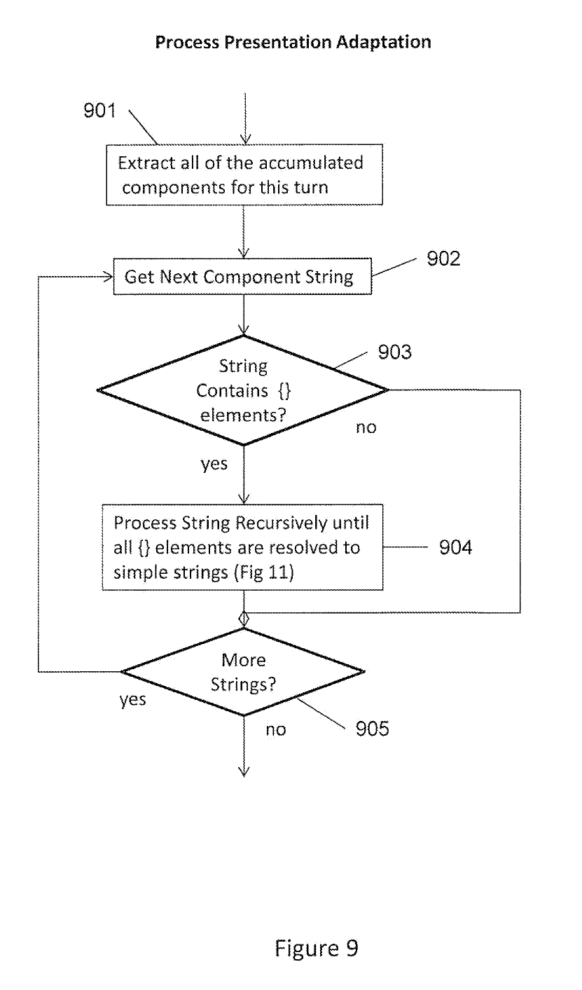

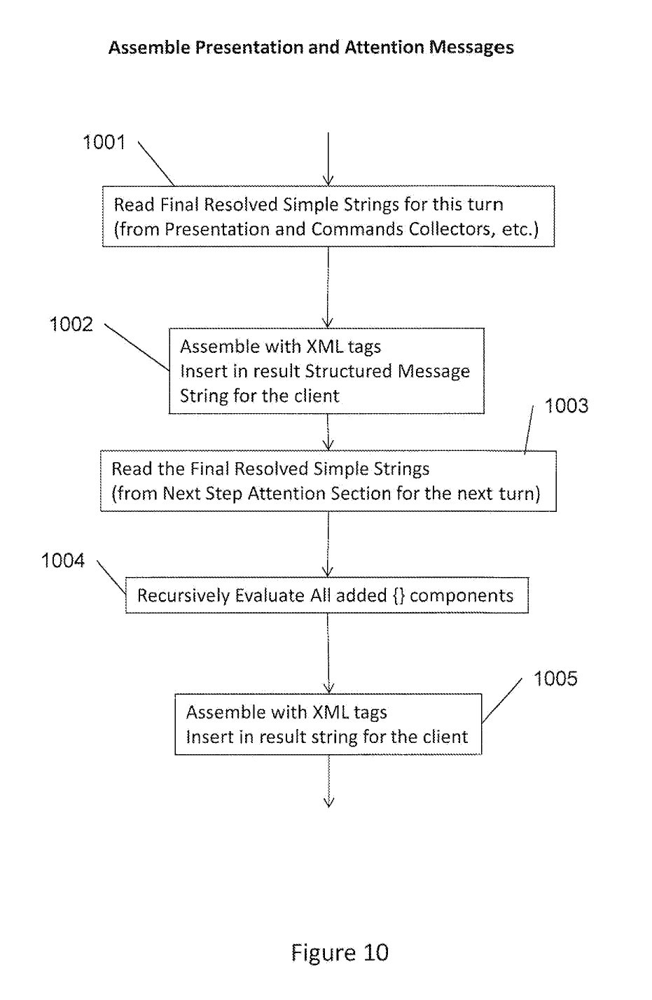

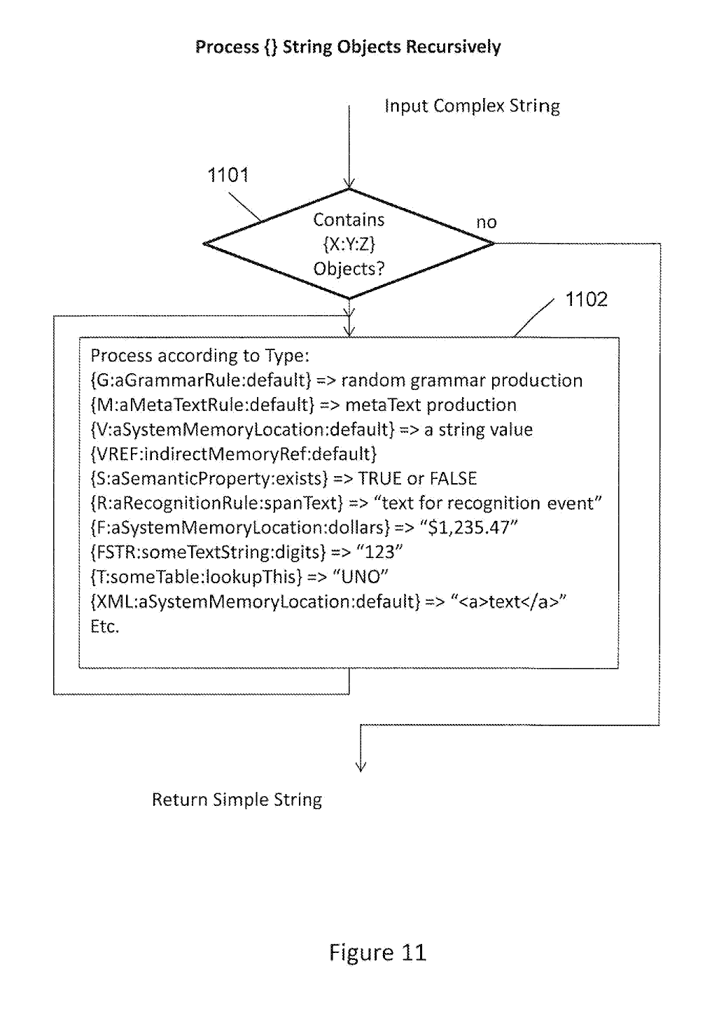

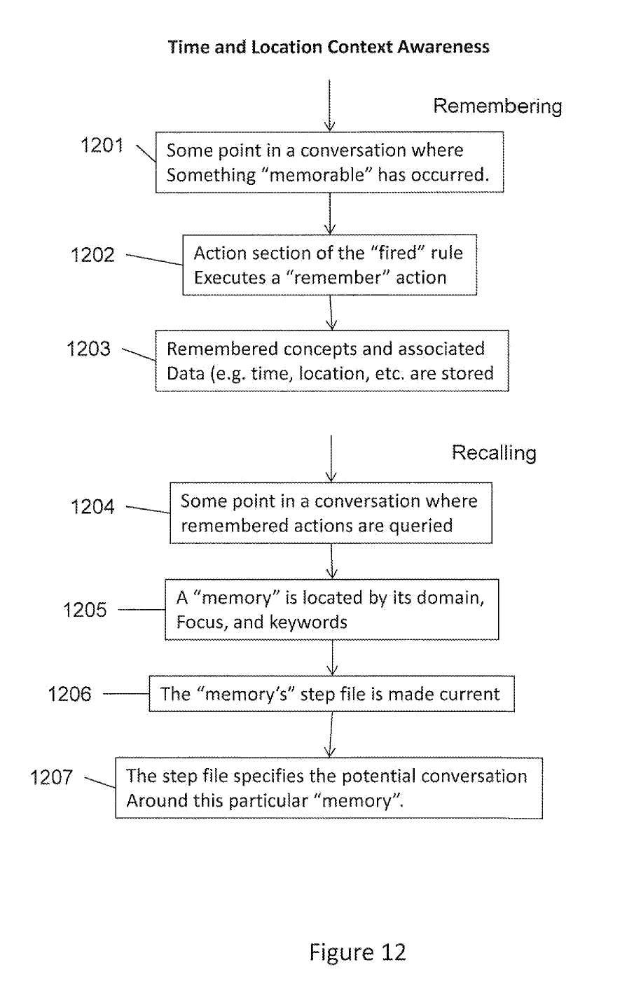

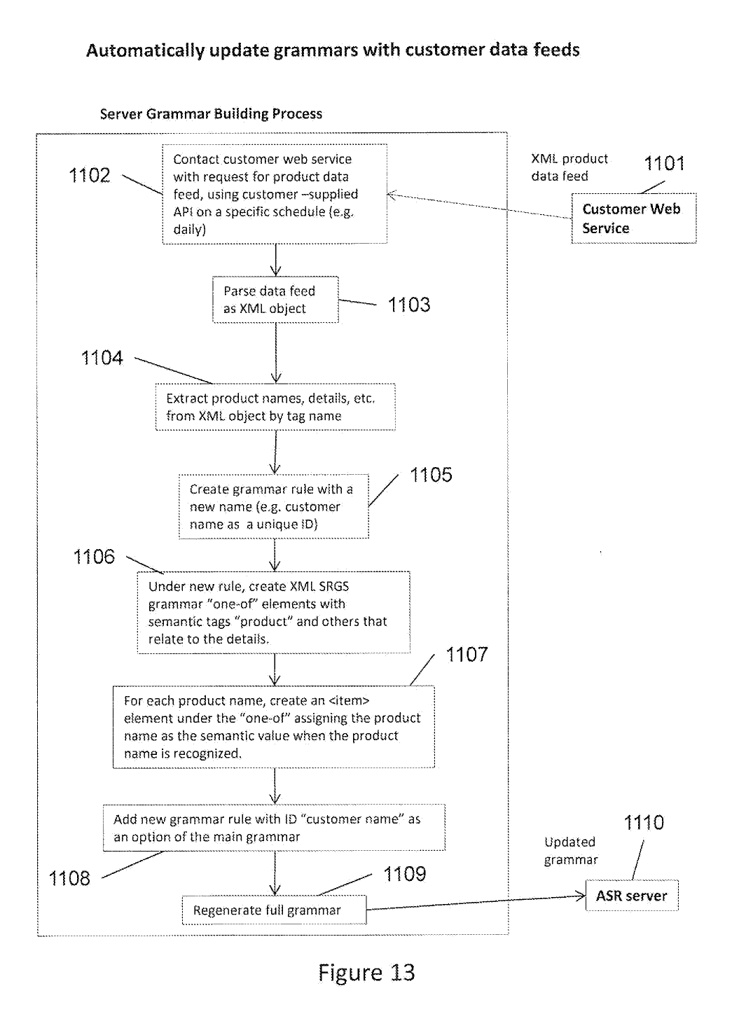

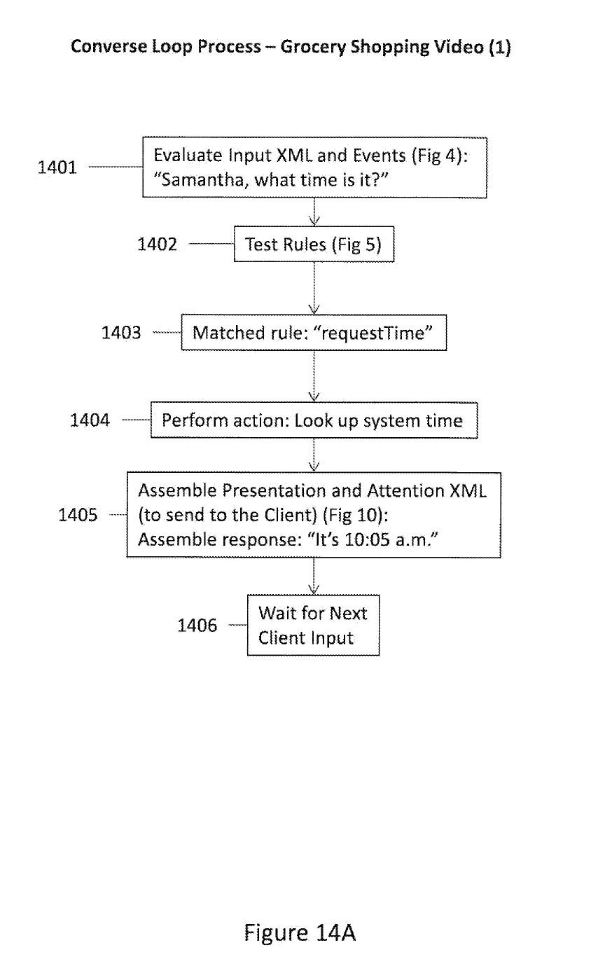

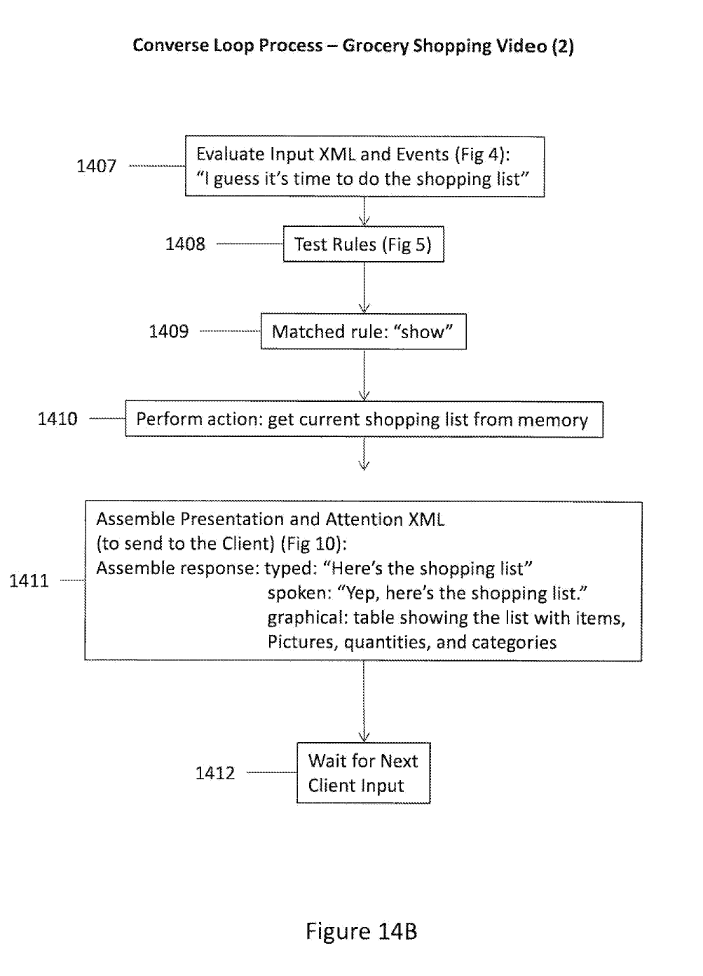

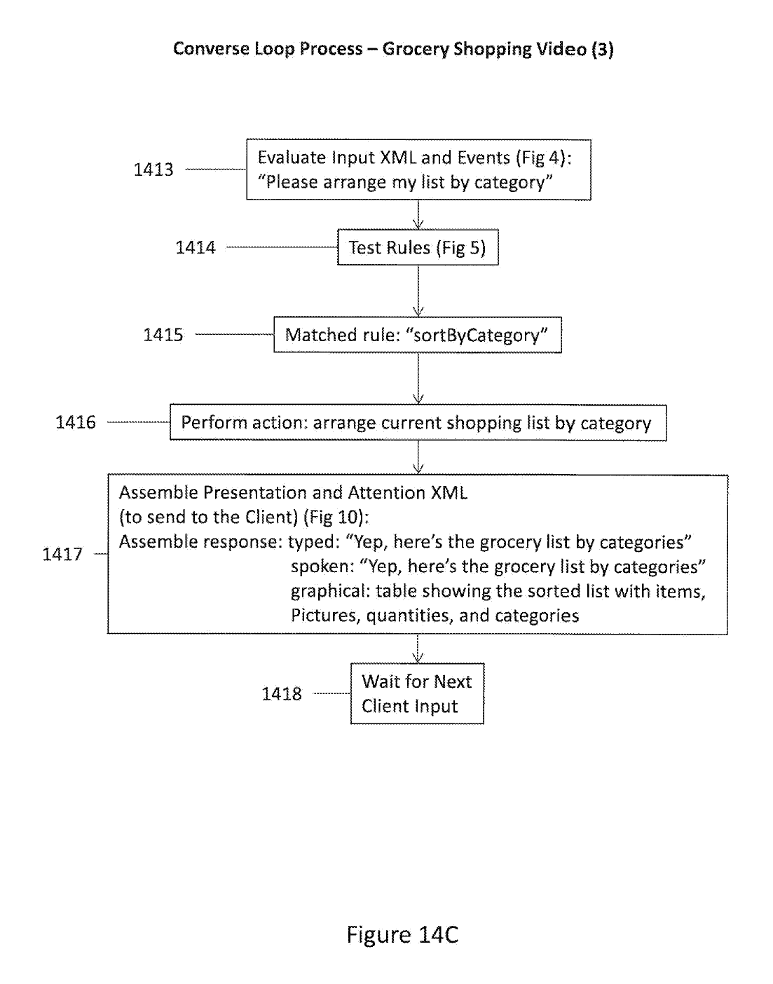

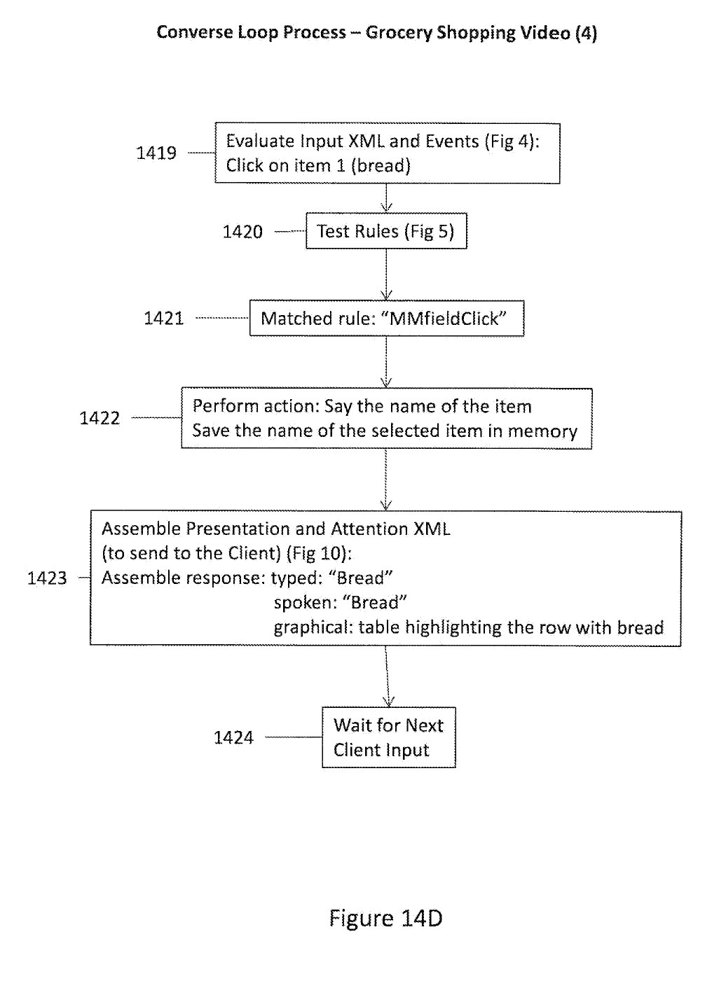

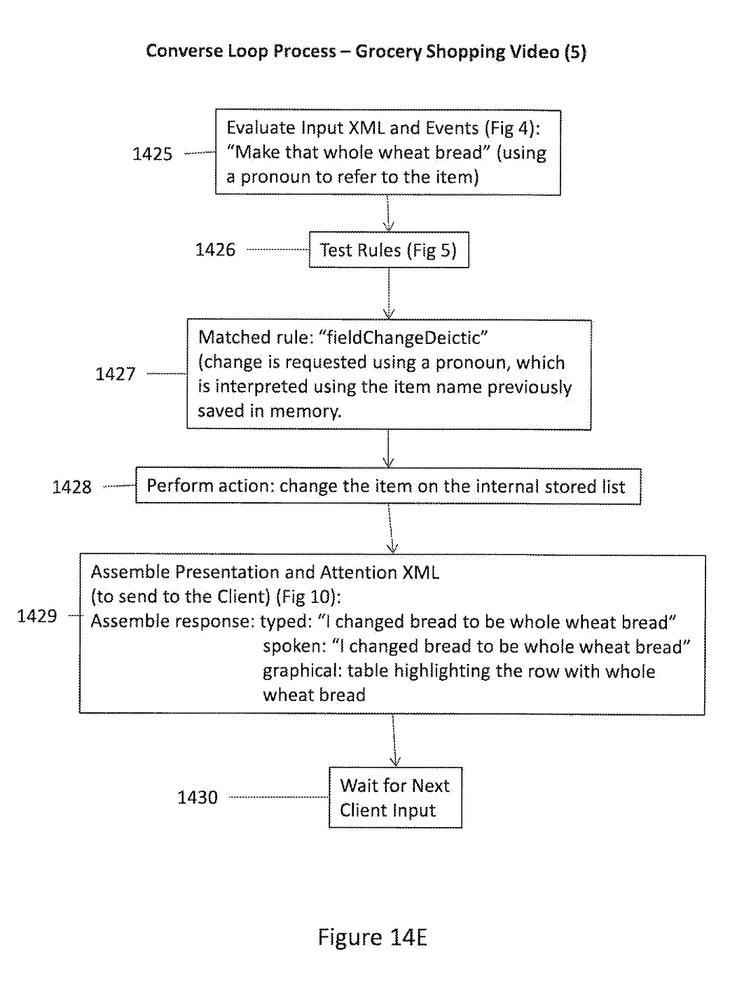

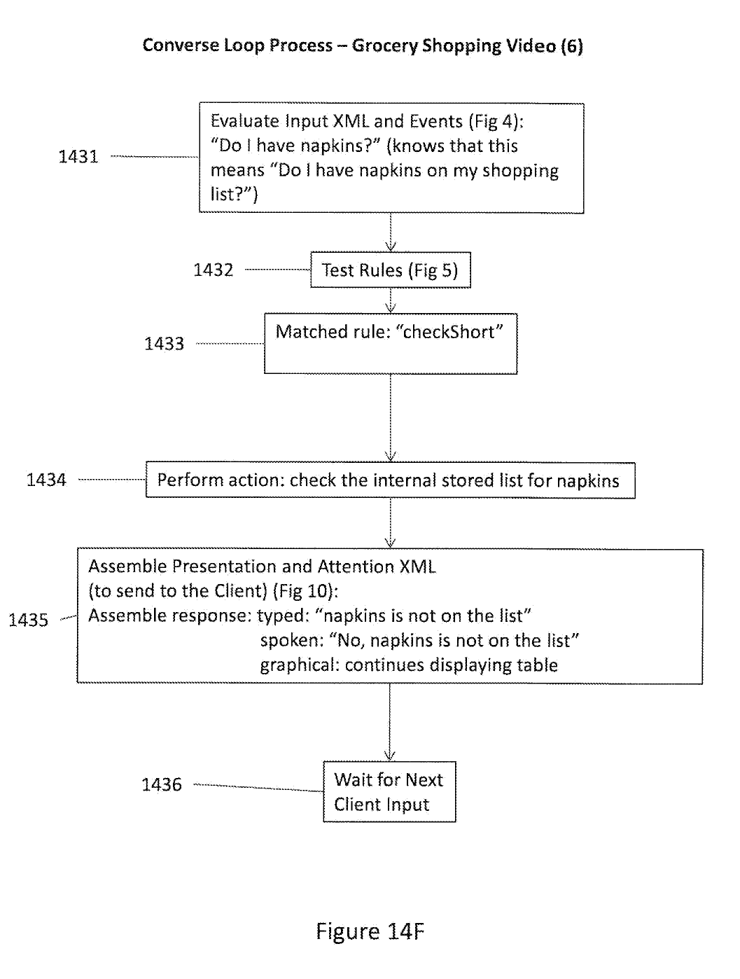

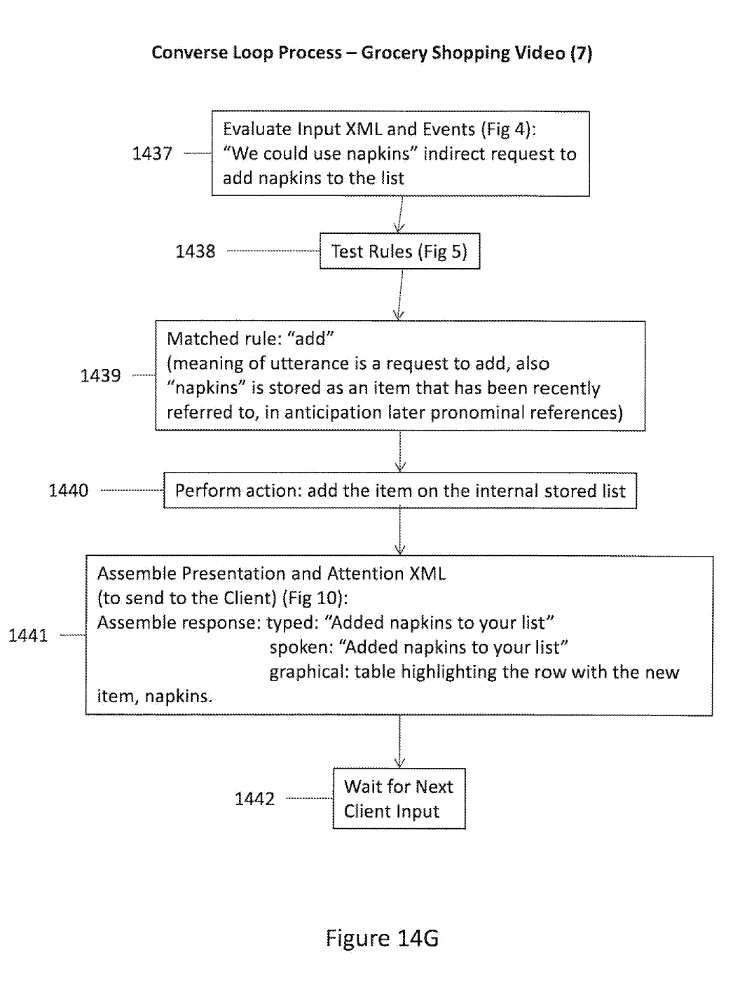

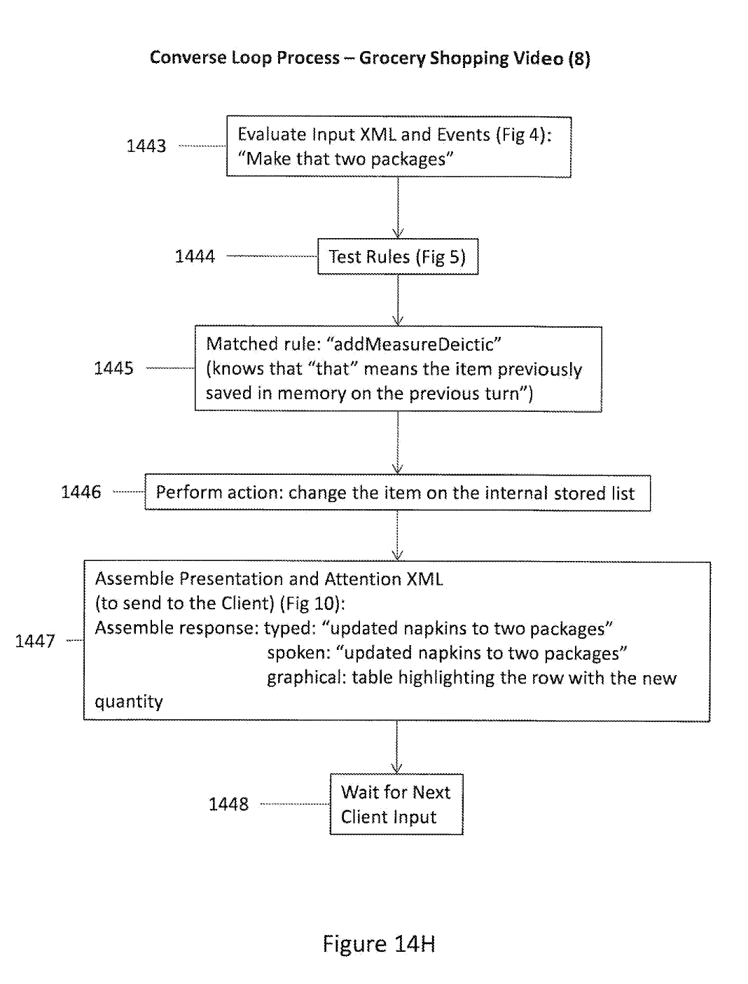

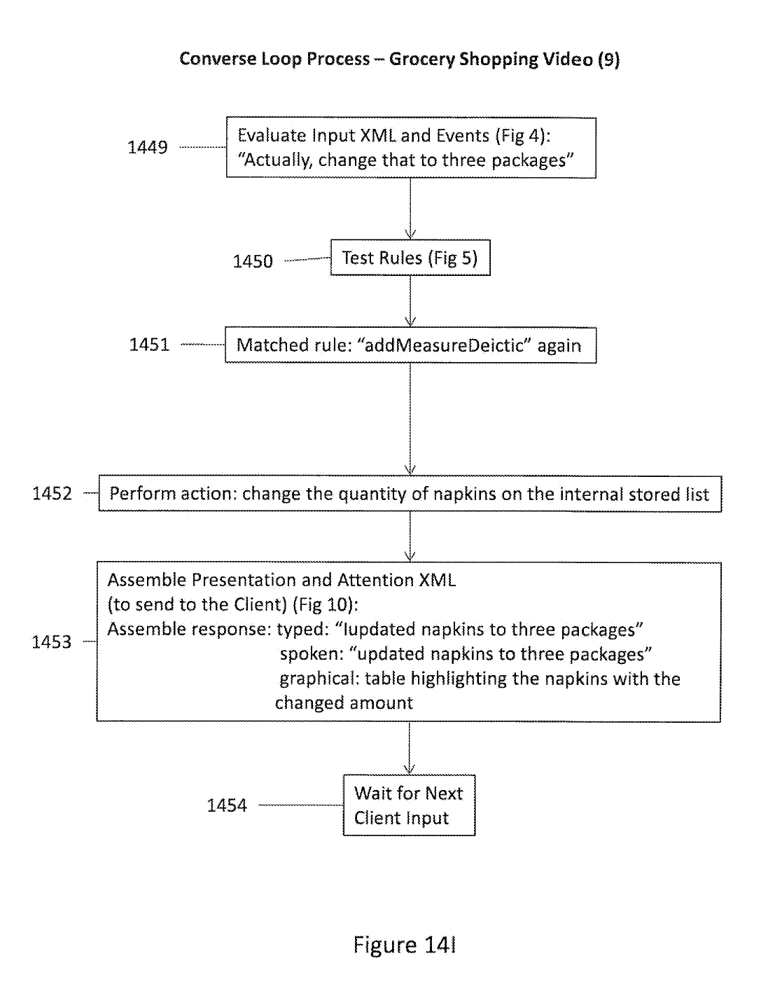

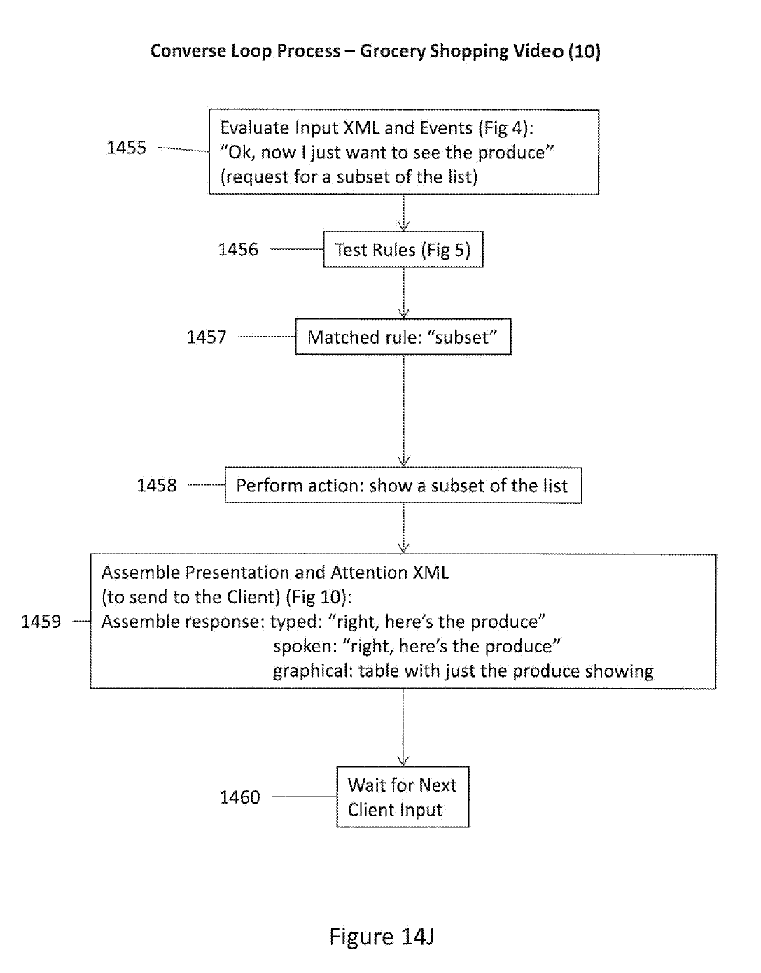

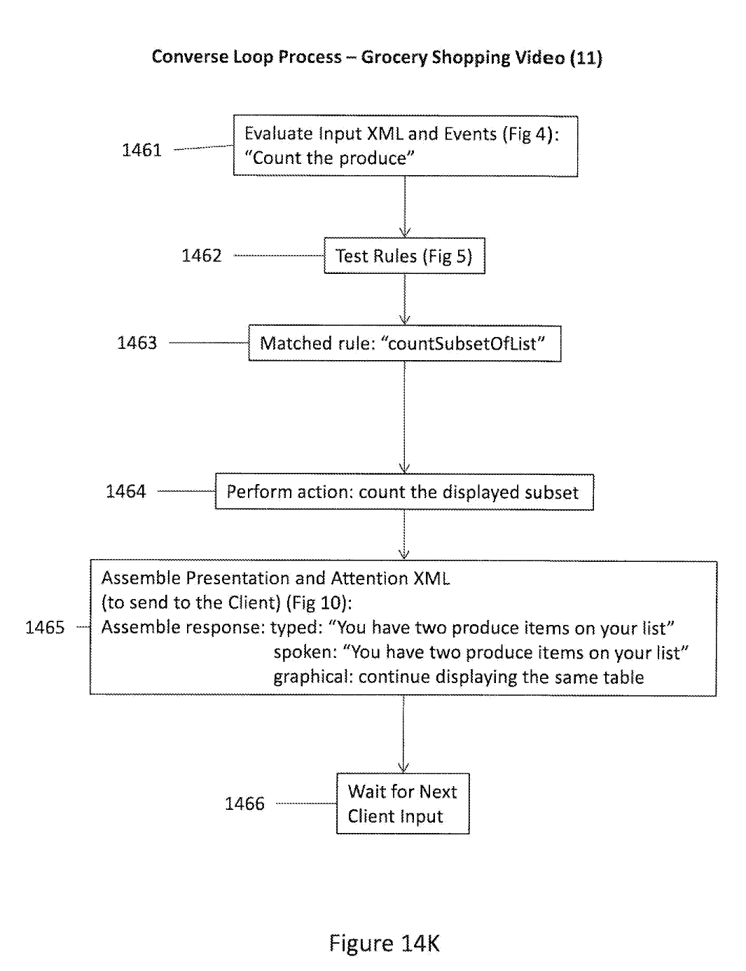

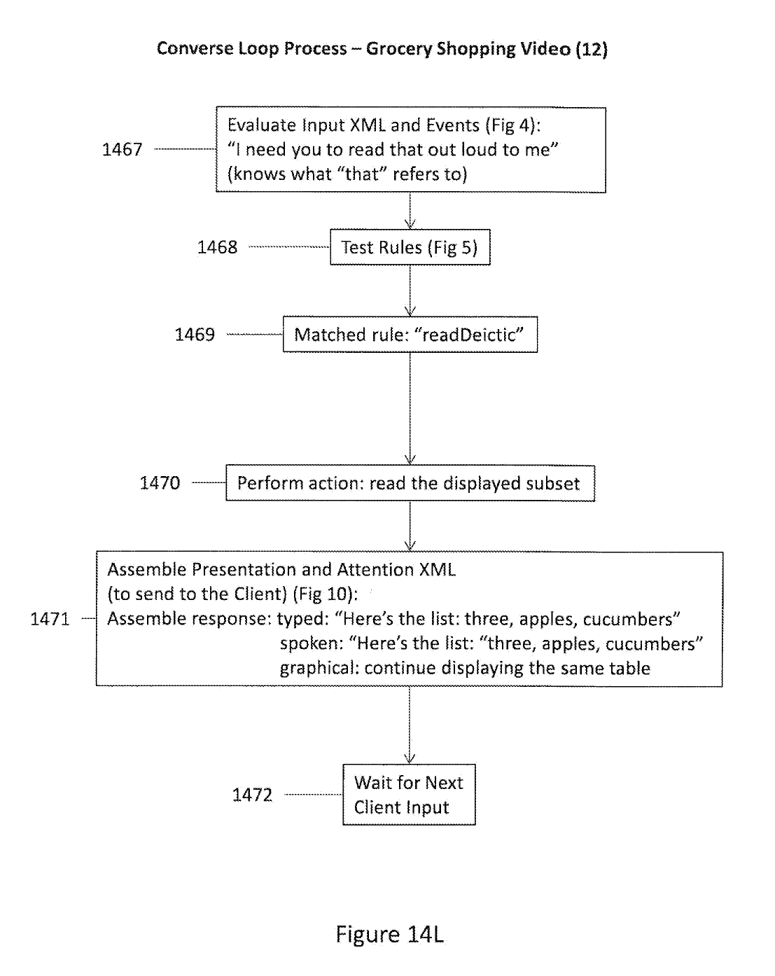

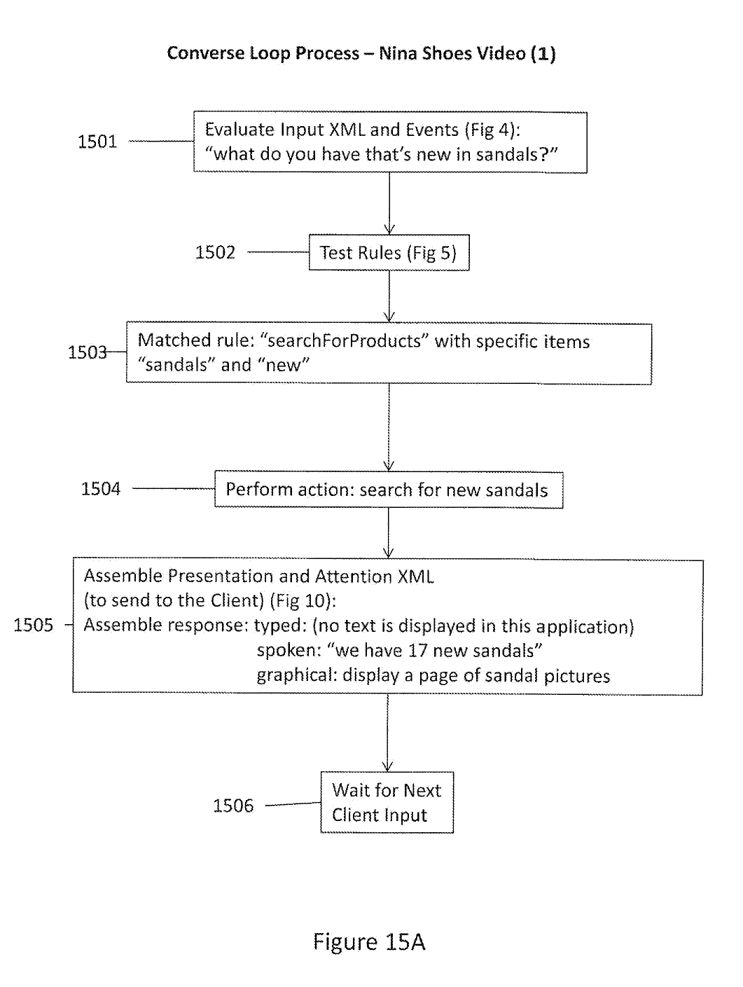

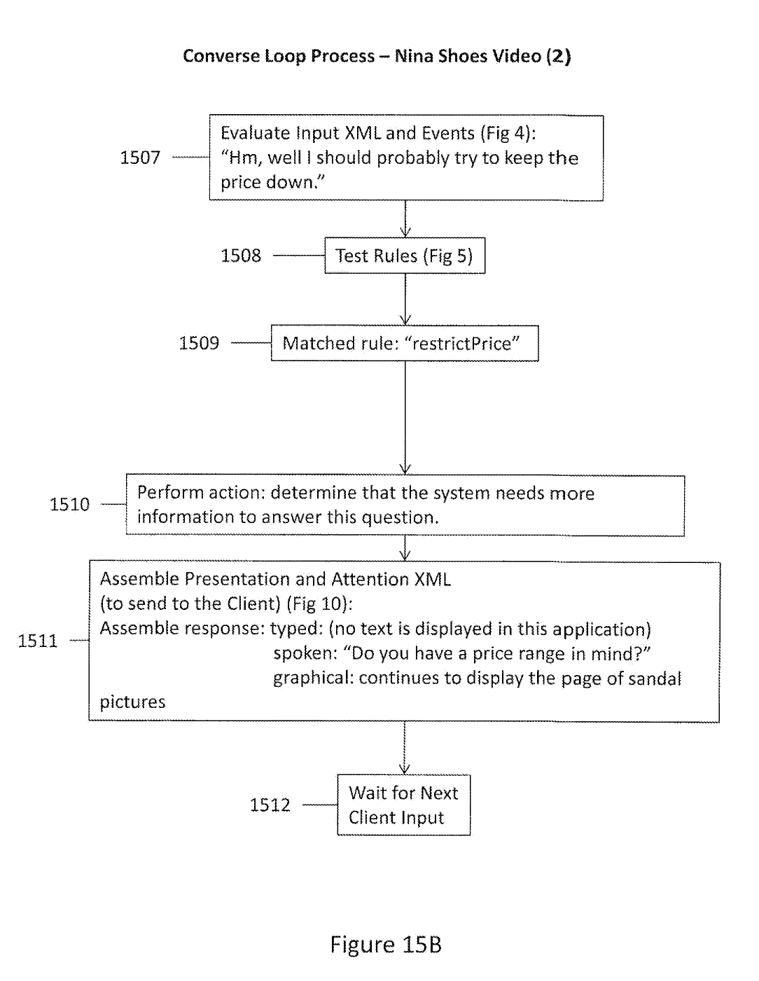

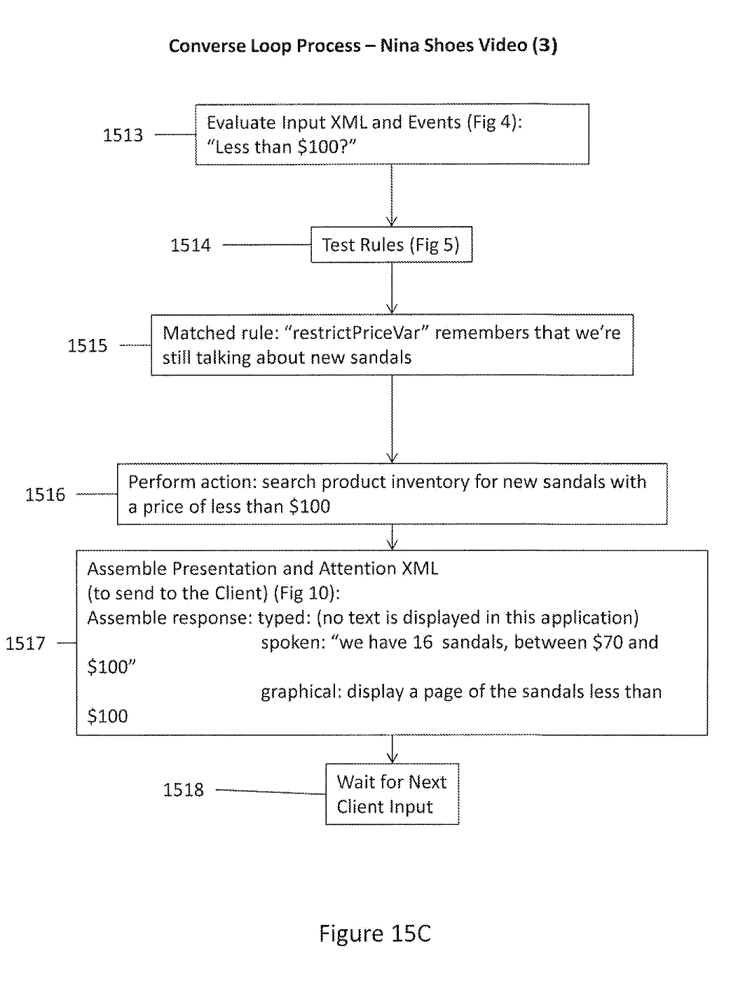

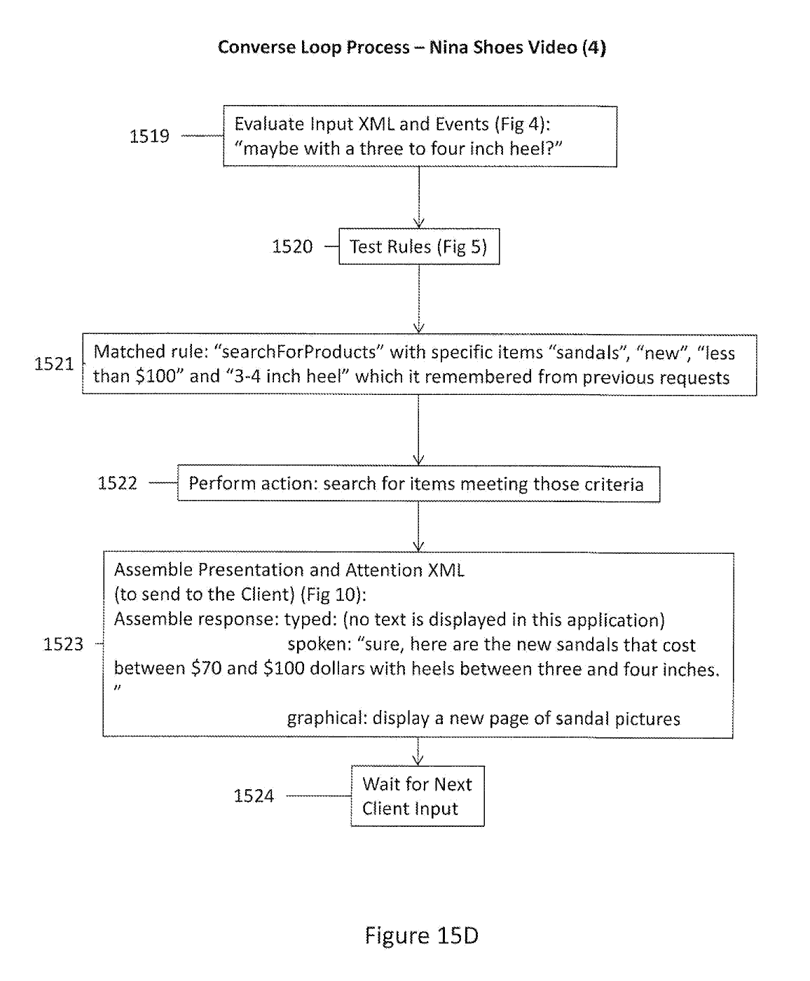

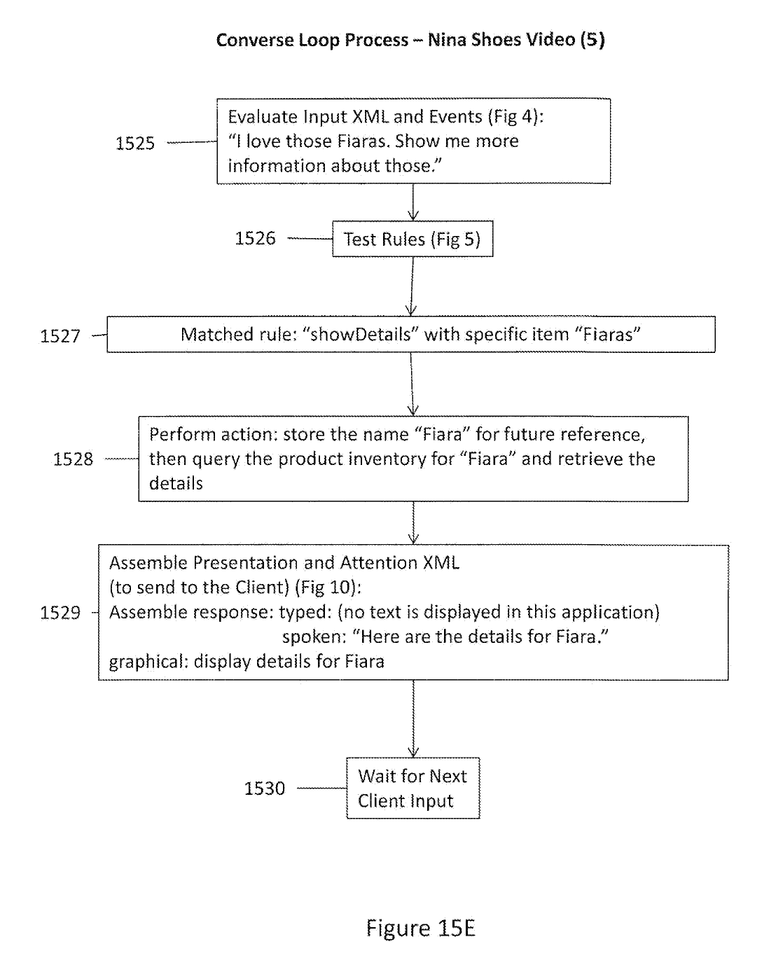

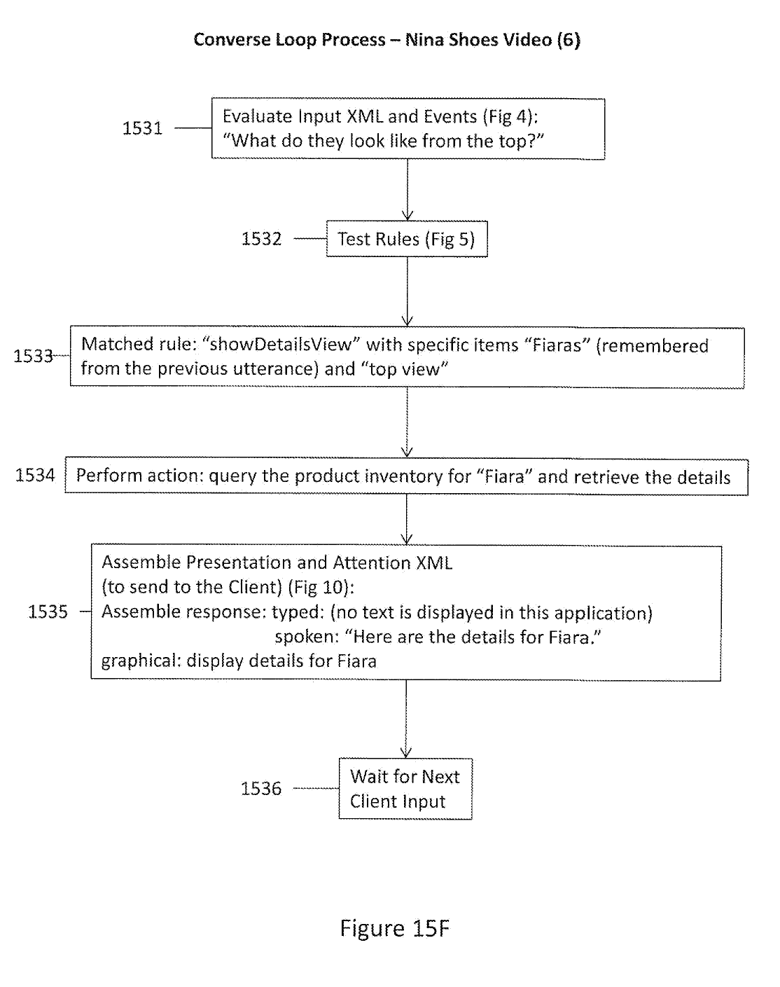

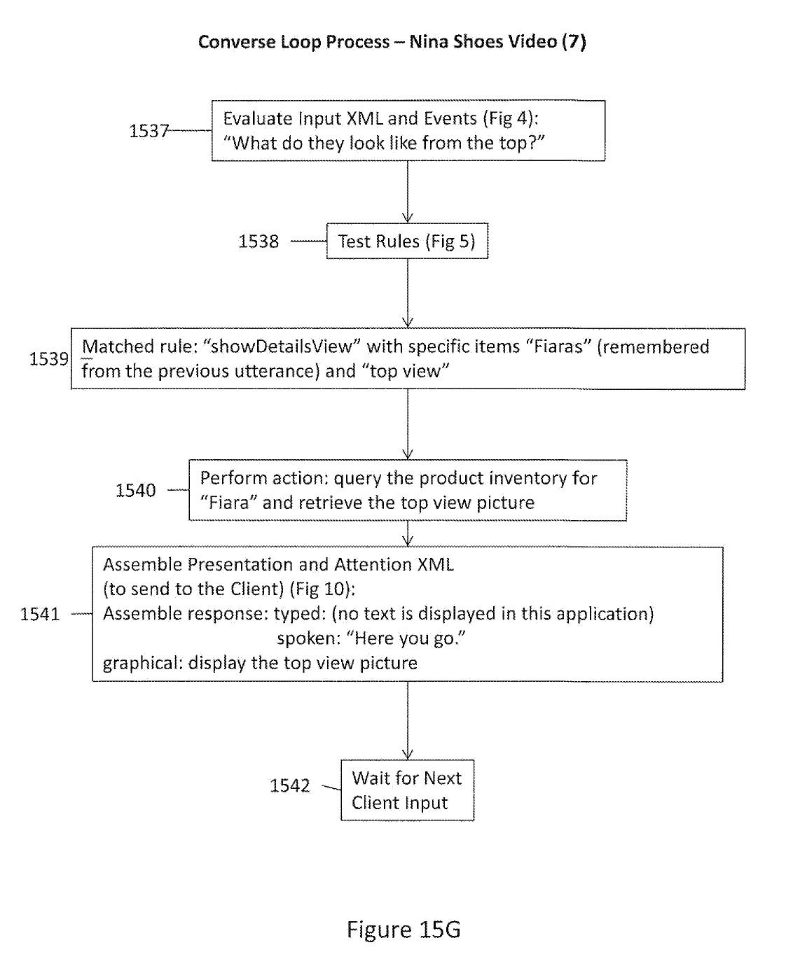

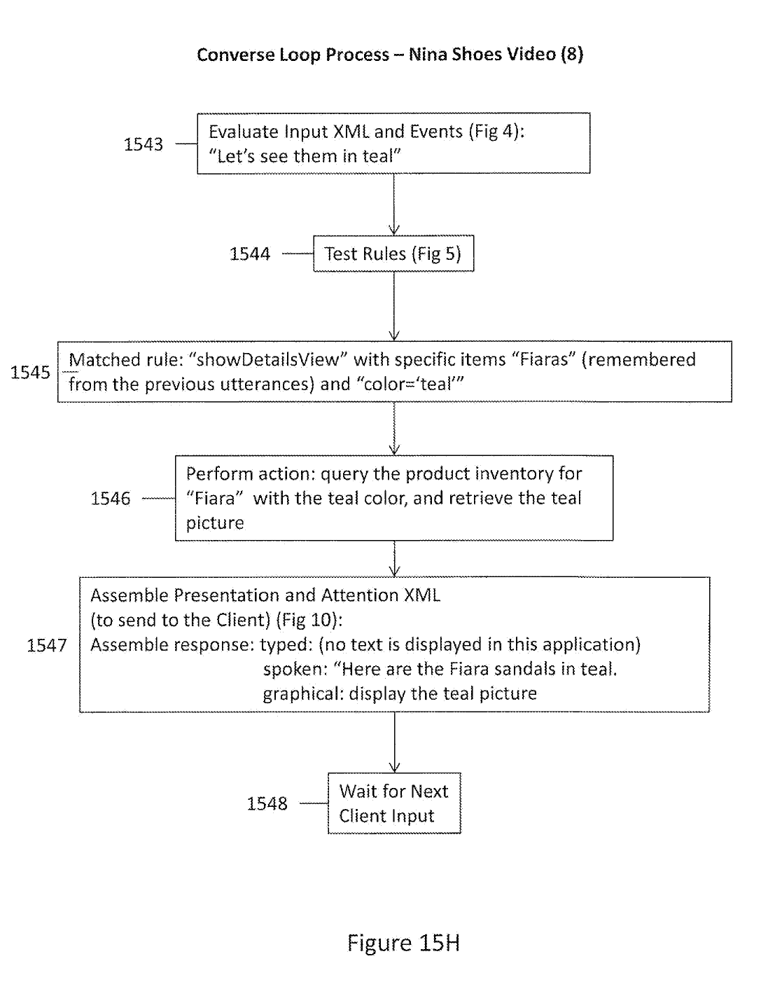

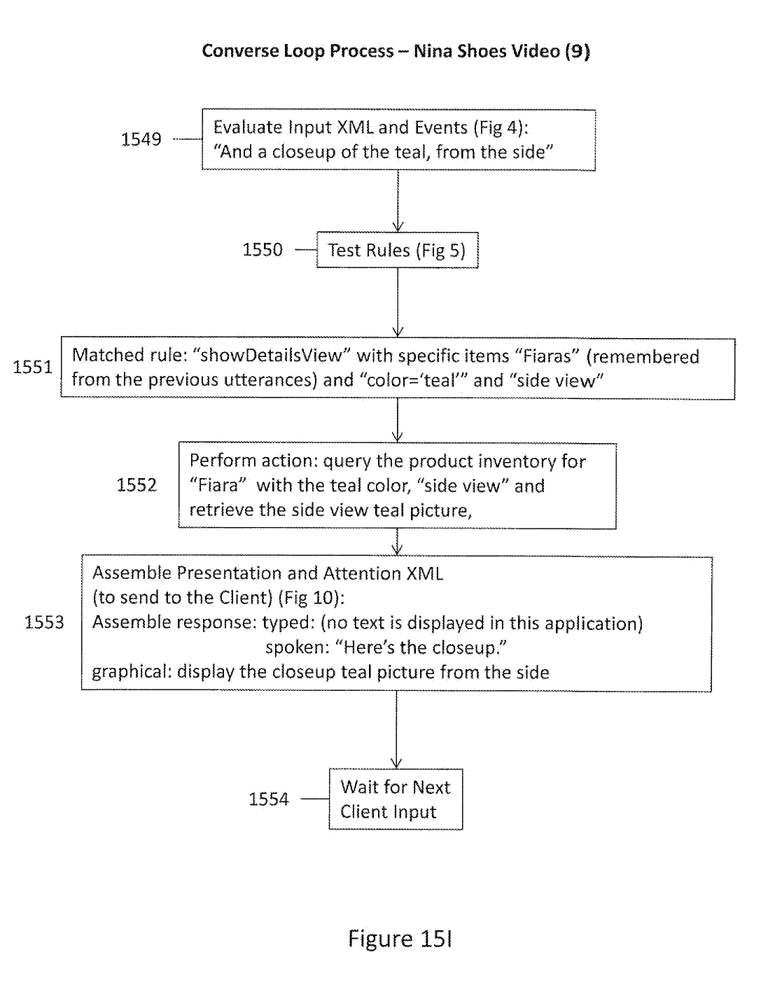

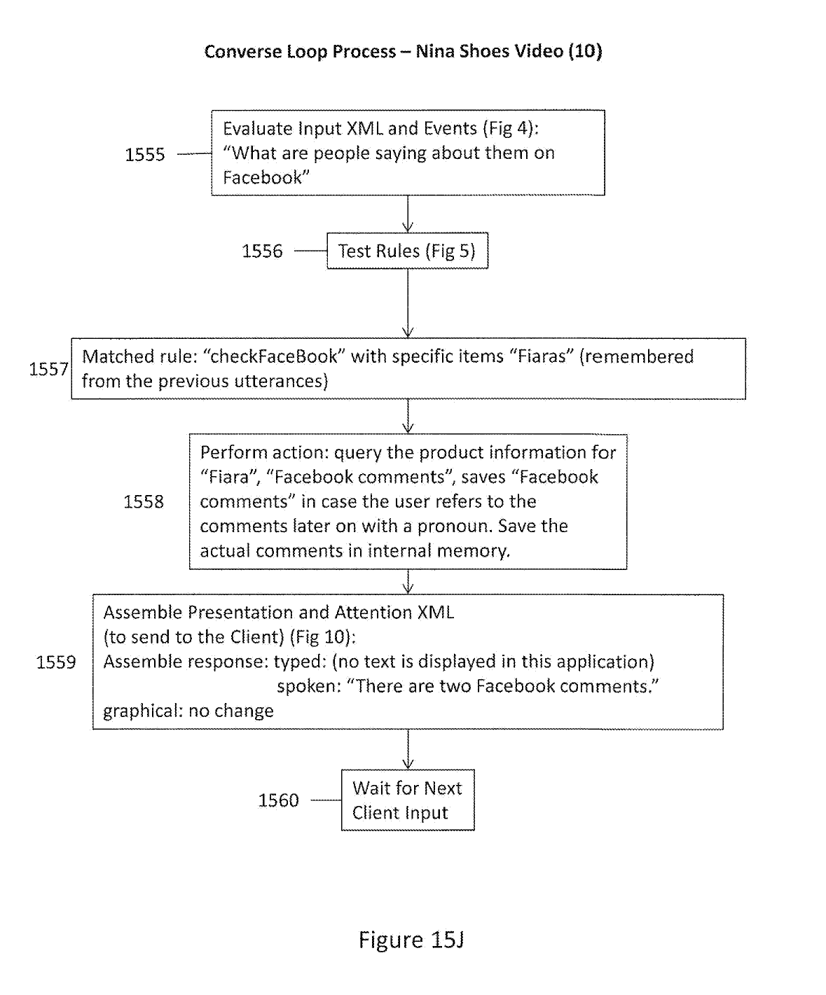

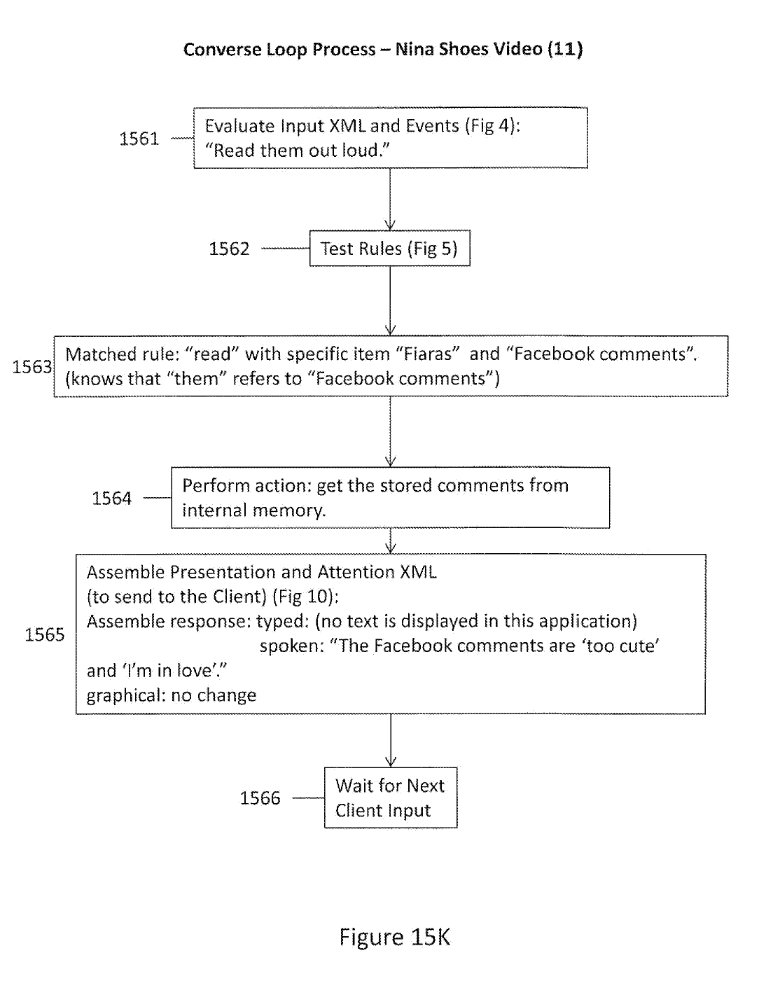

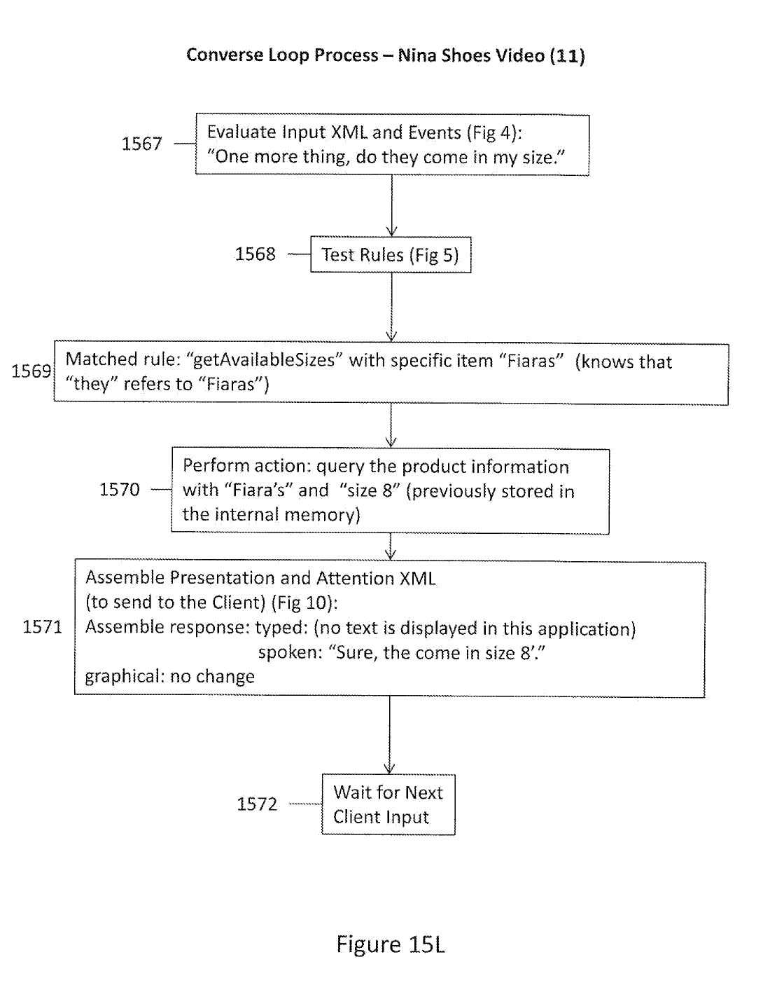

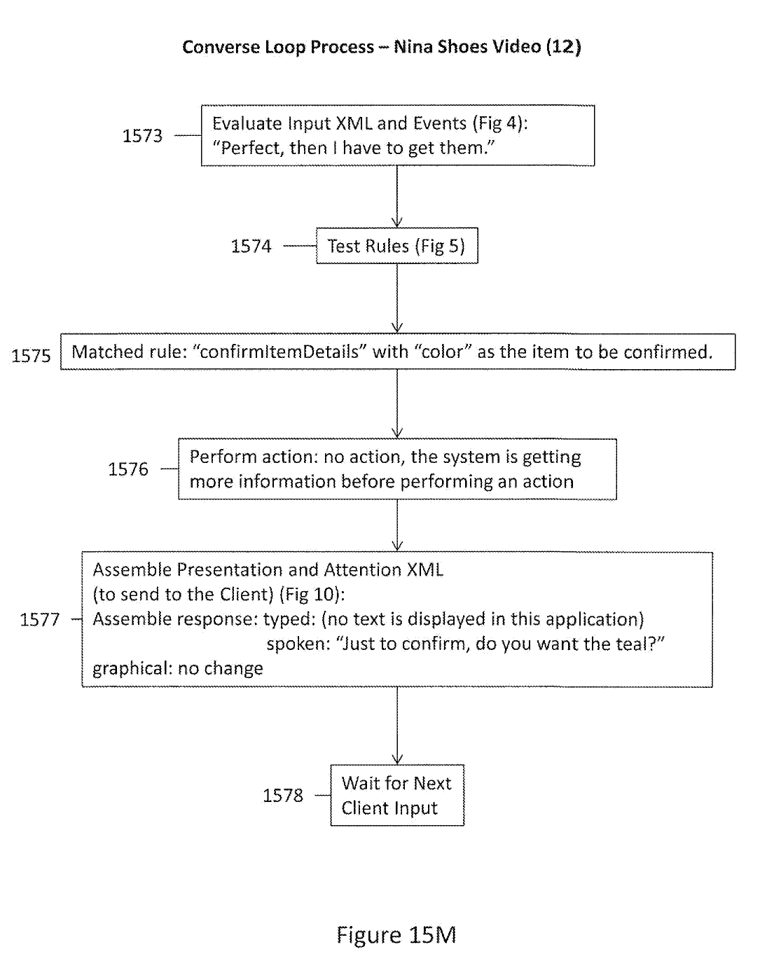

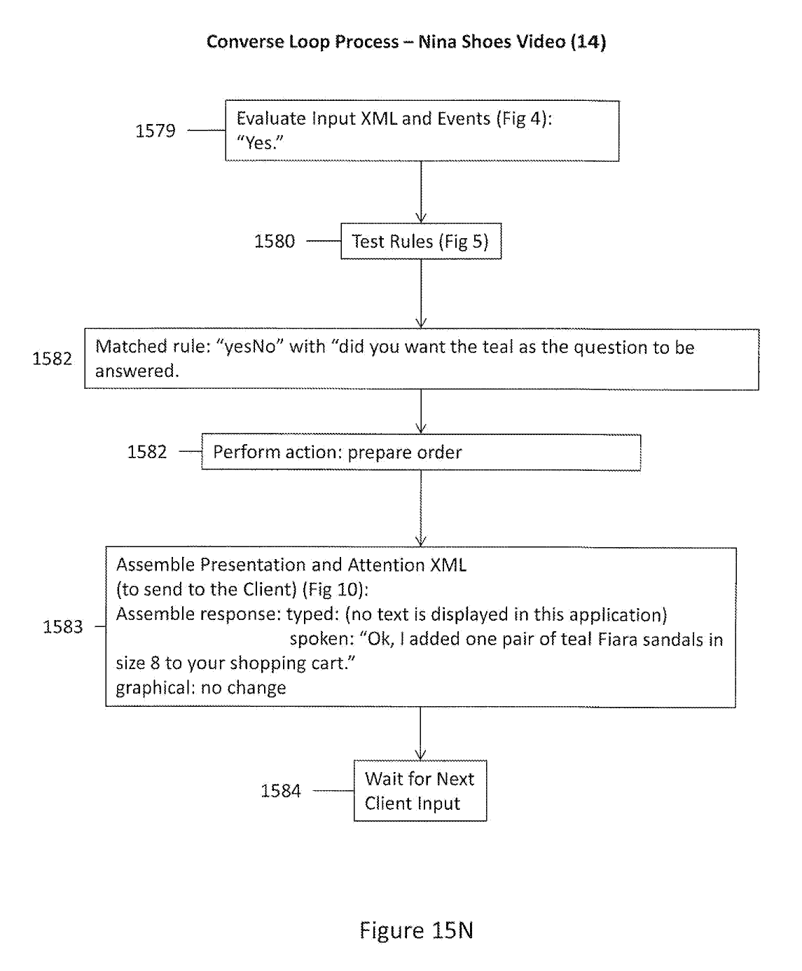

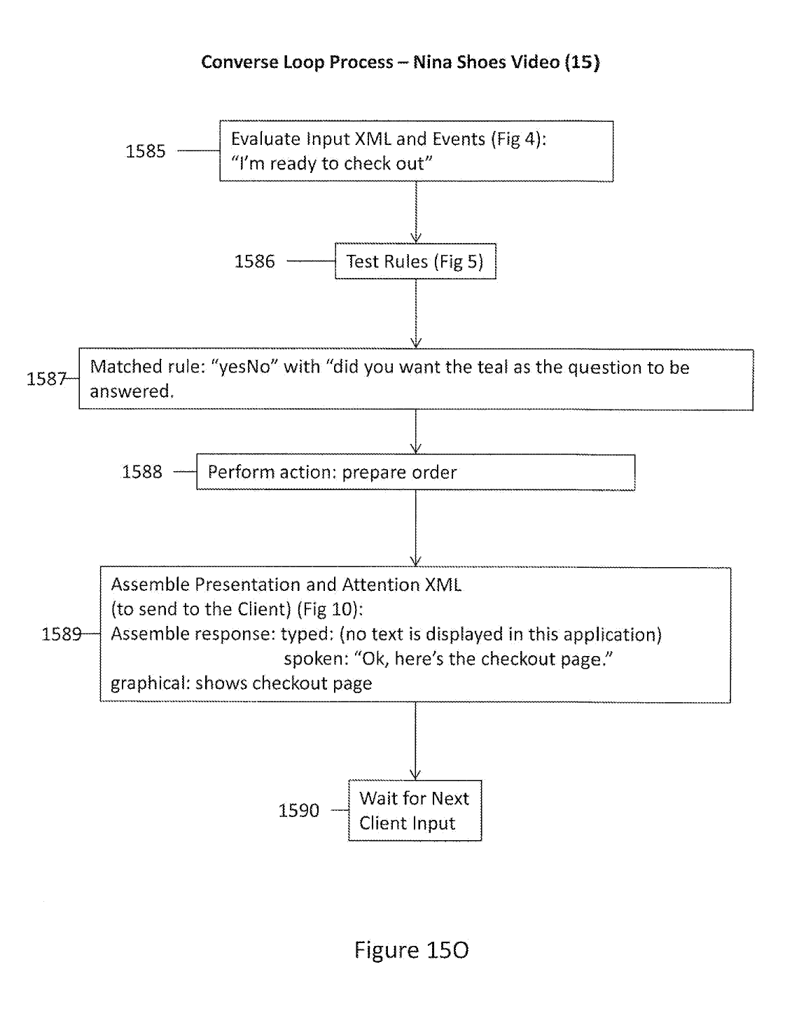

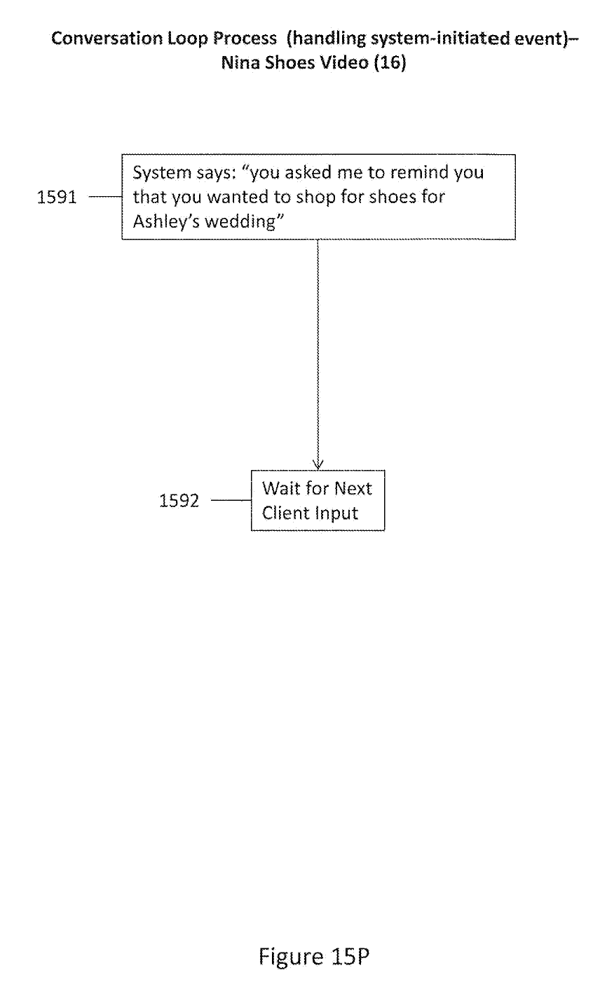

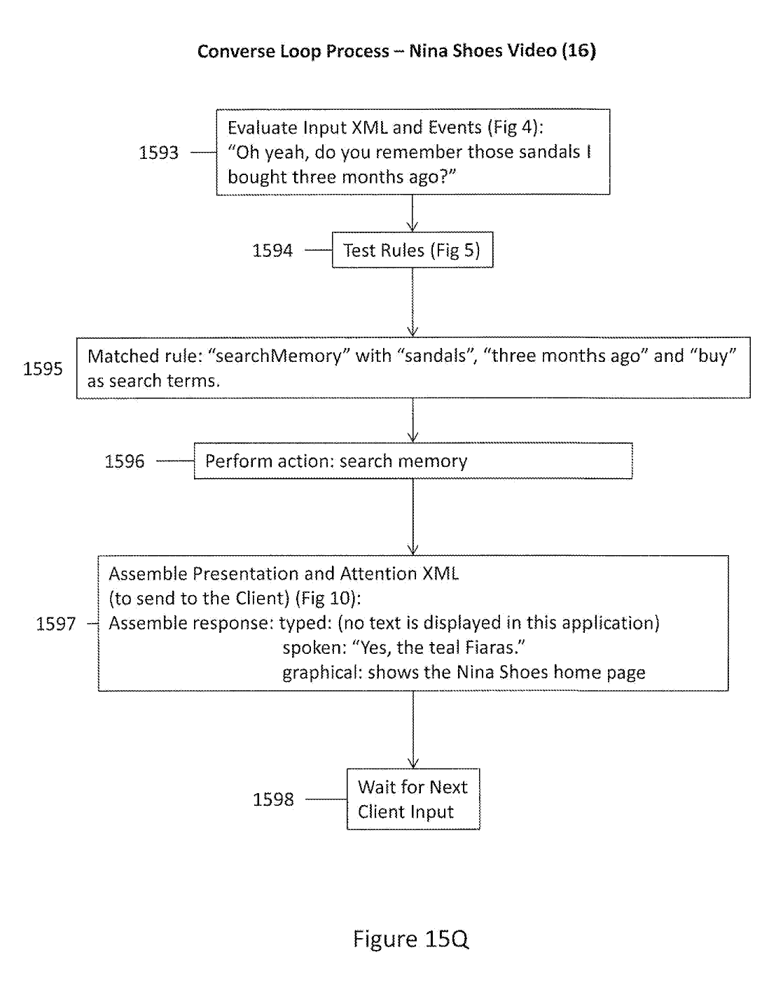

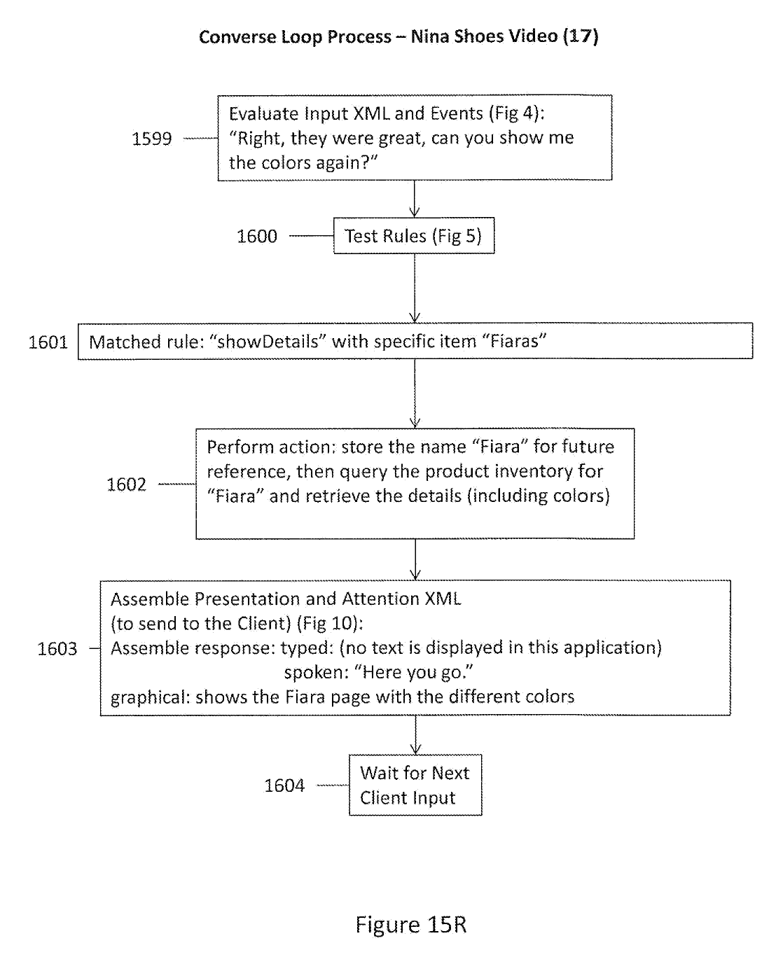

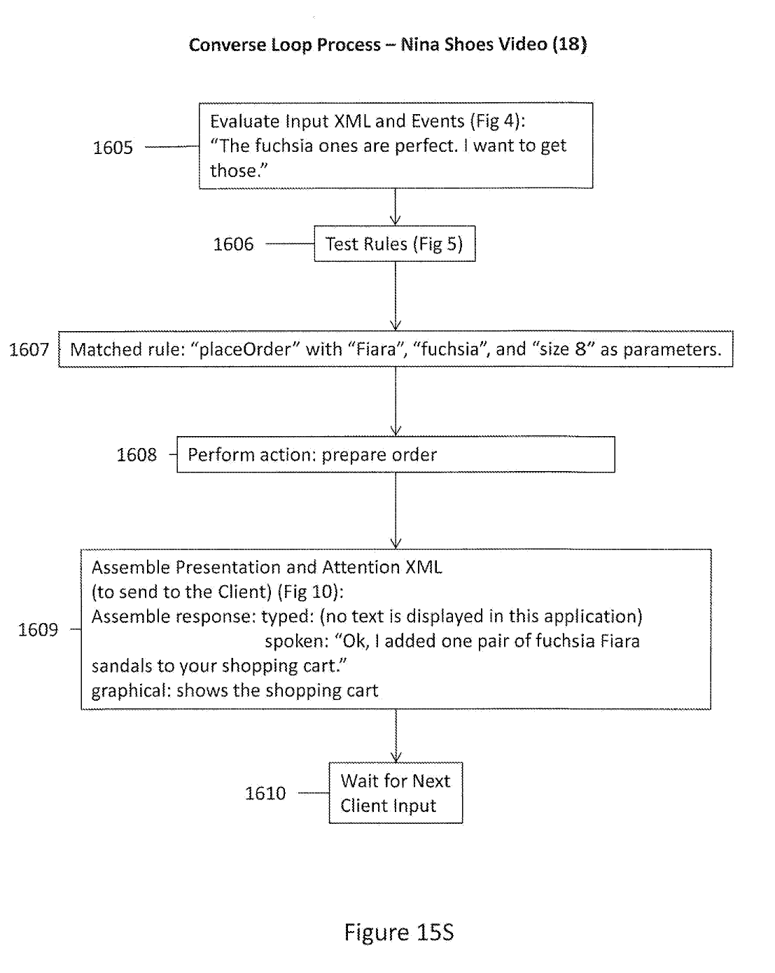

The first step is to evaluate the structured message input (301), which in this example is XML but as explained in FIG. 2 it can be any unambiguously defined data exchange formalism. This input message contains one or more results, reactions, or event's that the client has transmitted to the conversation engine on the server. The input message is parsed into its constituent parts and the evaluation process involves but is not limited to natural language processing of input text and/or speech recognition results, synchronization of multimodal events with other events such as a geolocation sensor report combined with a tactile input by the human. This evaluation will be explained in more detail in FIG. 4.

After the input is evaluated and formatted to be compatible with the rules that are part of the conversation engines specification files, then the single and/or combined inputs are tested against all of the rules that are currently active at this point in the conversation (302). The purpose of the rule of valuation is to determine the most appropriate rule that fits this particular point in the conversation. The rules can use as input things that include but are not limited to the raw input text that was the result of the speech recognition, semantic interpretation results that are returned from a speech recognition, natural language processing on the raw text, the returned character strings which constitute reports from the execution of client side commands, etc. Once the best matching rule has been found it may do further refinement by testing other input components as well as various contextual elements that are being tracked by the engine. Once all of the refinement is complete then the actions associated with that rule and rule refinements are processed. The results of this processing generate among other things behaviors and requests to be sent later to the client. Note: more information about how rules are evaluated are described in FIG. 5.

Part of the task of the rule of valuation mentioned above is to determine the direction of the conversation. The engine specification files support the declaration of moving to different domains or remaining in the same domain. The conversation engine evaluates the introductory section (303) of the domain that it is going to (even if that is the same domain) and executes any actions that are described. This includes but is not limited to text to present, speech to synthesize, visual displays to present, audio or video files to play, command requests for the client (for example geolocation or any other function available on the client), alterations of the conversational systems memory, calls to application function services, etc. All of the actions and behaviors that were generated as a result of the rule of valuation described in FIG. 5 are combined with the actions and behaviors that were specified in the introductory section of the target domain in preparation for transmission to the client. Note: a more detailed description of the process introduction section can be found in FIG. 8.

Process presentation adaptation is done on all of the combined actions and behaviors collected as described above (304). Any and all of those actions and behaviors can be declared at a higher level of abstraction. For example, in the case of text to be synthesized by text-to-speech engine on the client, if the conversation design engineer wanted the client US engine to say “hello” they could easily specify that constant string of “hello”. But a more natural way to declare this is with a combination of different phrases that have the same meaning such as “hi”, “hello”, “hello there”. At runtime the conversation engine would choose which phrase to use. This variability is not limited to just a simple list of choices, but could use a randomly generated production from a context free grammar, or a standard prompt that is modified to match the human users current sentiment, or generating conversational ellipsis (the natural shortening of phrases that humans do when they understand the context), or a combination of any or all of these things. A more detailed description of process presentation adaptation is in FIG. 9.

Presentation command and attention directive assembly is the final step in the conversation loop process (305). After all of the evaluation of the input, the evaluation of the rules, the process introduction servicing, and the process presentation adaptation is done then all of the components needed by the client are assembled into a structured message and sent as a single unit to the client. Note: FIG. 10 explains this assembly in more detail.

After the structured message has been sent to the client the server waits for the client to act upon the structured message and reply with its structured message (306). This completes the loop that represents each cycle of the conversation is managed by the conversation engine.

Flow Chart to Evaluate Input XML and Events (FIG. 4)

Note that for convenience we will refer to the input as “XML” for all of the following examples for this figure and other figures, but as explained previously this can be any structured data message that can be transmitted between computer processes on a single machine or across any network.

The conversation manager 10 checks for any pending events (401). The conversation engine is aware of time and timed event's. If a reminder or alarm has been set then it is checked to see if it is time to interject that event into the conversation loop. If an event is pending it is “popped off” an event queue (402). Events are not limited to just time, if the conversation specification has requested a geolocation and if proximity to a particular location has been set previously as an event trigger then that proximity can trigger an event. The way events can be triggered is virtually limitless and includes but is not limited to: exceeding a speed at which the client is traveling, the price of a product of any sort may crossing a threshold amount, the text of the subtitled evening news contains a specific word or phrase, etc. The engine has methods to set and retrieve all of these various levels and test them against thresholds. There is a method using an Application Function Server (AFS) interface supported by the conversation engine to support the detection and reporting of any event detectable by computer software software whether it is on the local machine or elsewhere and any extended computer network.

Once an event has been “popped off” the event queue it is then converted from the event queue format into a Conversation Loop Message (CLM) (403). The CLM is a single text string that is composed in such a way that it can be evaluated and tested by the rules in other of the conversation specification files (which usually but not exclusively exist in the step files that define the conversation). One such example for the CLM format for a simple reminder event would be:
“(ejReminder)meetingReminder.step.xml”

The above CLM for a reminder may be further refined and prepared by doing some additional natural language processing (406) on the string in order to make the rule evaluation (see FIG. 5) simpler and more robust.

As part of the conversation specification files a rule can be provided that matches that pattern. It would detect that this was a reminder because it contains the “(ejReminder)” substring. And subsequent processing as a result of that detection would result in the extraction of a specific step file name, in this case “meetingReminder.step.xml” which would then be used as a conversational domain specification for talking about for via any other modalities interacting with any meeting reminders that the human user may have. Note: this type of processing and detection will be discussed in more detail in the section called “evaluate rules” (see FIG. 5).

If no events are pending (405) then the complex input contained in the structured message from the client is parsed for any of the wide range of potential interactions that the human user can initiate. As mentioned in other figures these include but are not limited to: speech recognition of the human utterance, tactile interaction with the client side GUI interface, voice and/or facial recognition and verification, scanning of tags and/or labels (e.g. barcodes, etc.), geolocation reports, etc. This complex input XML is either received in a suitable CLM format and passed along directly or else it is further processed and formatted to be a valid CLM (404). As with the CLM for a reminder, this complex input XML may be further refined and prepared by doing some additional natural language processing (406) on the string in order to make the rule evaluation (see FIG. 5) simpler and more robust.

In many cases the complex input XML or the events that are triggered provide additional structured information that is useful for the conversation management. The simple CLM string is used by the conversation engine to decide what to do at a coarse level of granularity. This additional information needs to be prepared and structured and made available to the conversation engine so that it can be used in the subsequent conversational turns. (407)

For example in the meeting reminder example above the CLM allows a rule in the system specification files to “fire” that tells the conversation engine to prepare to talk about a scheduled meeting, but the CLM does not contain details about the specific meeting. The specific meeting information was loaded onto the conversation engine's persistent contextual memory behind-the-scenes by a separate reminder support module (408).

Another example that relates to the complex input XML (405) is a speech recognition result. At the highest and simplest level the speech recognition result contains the text of what was spoken by the human user. But in reality speech recognizers can report huge amounts of additional information. Here is a representative but not exhaustive list of this additional speech recognition information: a variety of alternative phrases and their order of likelihood, the confidence of individual words in the utterance, the actual context free grammar parse that the recognizer made in order to “recognize” the phrase, semantic interpretation results (e.g. the SISR W3C standard), word lattices, etc. All of this additional information can be used to improve the quality of the ensuing conversation and it is made available to the conversation engine by loading it onto the conversation engines persistent contextual memory (408).

Evaluation Rules (FIG. 5)

FIG. 5 describes one method in which the “rules” in a conversation specification file are evaluated. This particular method describes an iterative loop of testing and evaluation but it is not the only way that rules may be evaluated. In some implementations it is advantageous to evaluate all the rules in parallel processes and then to select the rule that “fired” as a simple or secondary process. So for clarity it will be described as an iterative loop.

When evaluating rules the conversation engine looks first at the current domain which is represented by the topmost or “active” step file at this point in the conversation. Each step file in addition to having an introduction section and an attention section contains a response section. This response section contains zero to many rule sections. Rule evaluation begins with the first rule section and proceeds to the next rule section until one of the rules “fires”. So to begin the process that evaluates rules the conversation engine accesses the current active step and within that step accesses the first rule (501).

The conversation engine determines if this rule is active at this point in the conversation (503). Some examples of the ways in which rules can become inactive at specific instances in a conversation are: if they are resident in a step file that is too many derivations removed from the current domain, or if too much time has passed since there was conversational activity in a domain. These are parameters that can be specified on a rule by rule basis.

The conversation engine is based on object-oriented principles and much of the behavior and power of the system at any point is a function of the incorporation of derived behaviors from other conversational domains. So a mechanism such as derivation distance helps to distinguish which domain and utterance or other input is intended for. For example, “one thirty” would most likely be correctly interpreted as a time if the conversation were centered on trying to schedule something such as a meeting, but it would be most likely be correctly interpreted as an angle if the conversation were focused on gathering information from a land surveyor.

Similarly, very short utterances or very concise multimodal directives that rely heavily on very recent context (e.g. a part number which is presumed to be in the human users short term memory) should result in different behaviors depending on whether they happened immediately for a minute or two later. This is one of the ways in which the conversation engine can adapt and natural and appropriate ways.

If the currently referenced rule is not active then the conversation engine tries to advance to the next rule in the response section (506). If there is a next rule that it loops back and determines if that rule is active (503). If there is not another rule the conversation engine examines the derivation specification of the step file (504) and if one or more step files are specified in the “derived from” section then the conversation engine changes its search focus to those step files (502) and proceeds to examine the rules within their response sections (501). Note: these derivations of step files can be nested as deeply as is required in the conversation engine will consider them in a depth first tree traversal path.

If there are no more steps to derive from and the derivation tree traversal has been completed then no rule has “fired”. The conversation engine treats this as if no input had been received and the conversation is left in exactly the same state it was at the beginning of this conversation loop. Ultimately the conversation engine will send a structured message that reflects this same state back to the client and wait for further interactions.

In the event that a rule is active (503) then the conversation engine tests whether any of the rule patterns match the input. The simplest of the matching mechanisms that can “fire” a rule our basic string comparisons using wildcards, but these can be built into more complex comparisons by methods including but not limited to: extracted input semantics from speech recognition or other sensors, the existence and/or values of things stored on the system persistent contextual memory, experience level at this point in the conversation, etc. If the pattern is not matched then the rule does not “fire”. The conversation engine then attempts to examine the next available rule (506).

If the pattern is matched and the rule does “fire”, then the behaviors and actions specified within that rule are processed and acted upon (see FIG. 6).

Process Rule (FIG. 6)

After a rule has “fired” the conversation engine executes all of directives contained within that rule plus any reference directives including but not limited to: external scripts, metatext adaptations, random grammar-based text string productions, application function server programs, etc.

First the conversation engine does some overall general context tracking and recording (601). Information including but not limited to: the time this rule fired, the number of times this rule fired since the beginning of the conversational relationship, the current experiential status (which is computed from coefficients for “learning impulses” as well as “forgetting rates”), etc. All of this information is stored on the system persistent contextual memory and is used in later evaluations and expansions to manage the natural adaptation and variability that the overall conversation engine exhibits.

Every rule contains an action section. In the action section contains a range of directives that define the actions that will be taken in the event that this rule “fires” (602). These directives can be specified in any order and nested to arbitrary depth levels as needed.

Specific actions within the action section include but are not limited to:

1. setMEM section which allows the conversation at this point to set values on the conversation engine's persistent contextual memory. It has methods to set multiple values, to copy values from one place in the persistent contextual memory to another by reference as well as by value, to use dynamic parameters to specify the variable location and or the variable value.

2. Presentation section which contains multiple elements representing the multiple modalities that the client can present to the human user. This list includes but is not limited to: text to display, text to be spoken by a text-to-speech synthesizer, a semantic to display what the conversation engine understood at a high level, an overall emotion, gestures (these are applicable to avatars), media files to play, etc. Note that this list can be expanded easily to add any other modalities which a client platform can present to a user (e.g. vibrate, blink indicators, etc.). The presentation section (along with the command section) have a special feature that allows them to collect and combine during the entire process of setting up for the next turn, rule “firing”, and further refinement of a particular rule “firing” right up until the eventual transmission of a structured message back to the client.

3. Commands section which can add and accumulate zero too many individual commands that will be included in the structured message that is sent back to the client (see the description of presentation above).

4. Switch section which assigns a value to a “switch variable” that can be used immediately within the switch section to select one of several subsections (which can be referred to as “cases”) to be executed based on matching the value of the “switch variable”. This behaves similarly to the “switch” language element in many common computer programming languages.

5. DisplayHTML section which is used to compose HTML (or other display formalisms) either in place or by reference to display information elsewhere on the conversation engines persistent contextual memory. This composed display information is included in the structured message that is sent back to the client where it is displayed.

6. Script section which is used to refer to other snippets of “action” directives. It provides a method by which to reuse common or similar sections of action directives in a method analogous to “subroutines” in other computer programming languages. The files that contain these scripts are part of the conversation specification files used by the conversation engine.

7. Remember section which can commit relevant memories to the persistent contextual system memory in such a way that they can be recalled and used in conversation in a natural and efficient way. For example, remembering a set of glasses you ordered last month from an online store allows the conversation to easily transition to something like “let's order another set of those glasses”. Based on the “memory” of the last purchase buying another set becomes simple.

8. Application Function Server (AFS) section is used to access functionality that would be either too complex or inappropriate for the conversationally oriented functions of the action section described here. Some of the AFS functions are internal and they include such things as: doing arithmetic, managing the navigation and display of lists, placing reminders on the persistent memory, etc. AFS functions can also be external and as such they are registered in a startup configuration file with a simple name in the appropriate communication protocol (simple socket, HTTP, etc.) and with the necessary connection and communication parameters. Then that any point in the conversation a step file (one of the system specification files) can request the external AFS function by its registered name and expect the resulting information from that request to be placed on the persistent contextual system memory at a location specified by the AFS call. Note that these external AFS functions are written independently of the conversational specifications and can provide any functionality that is available on the computer or via the networks that the computer has access to. The AFS methodology permits the design of the conversation to be done independently of the design of any computer science like support functionality. The conversation specification simply references the results of the external function and uses them as needed and as is appropriate.

9. AdaptLM section which permits the accumulation of phrases that may be used for tuning or expanding the language model used by the speech recognizer for the natural language processing subsystems.

After all of the action elements (and any of their multiply nested sub elements) have been executed one last level of refinement for this rule's behavior is optionally available. If this rule has a “branch” section (603) then based on the status value, which is either selected explicitly or presumed implicitly as the result of the most recent AFS or switch element, the conversation engine will select one of the “case” sections (604) which are included in the branch section. This selected “case” section contains further actions as described above that further refine the system's behavior based on the status variable. These actions are executed at this point (605).

After the branch section has been processed or if there is no “branch” section or if none of the “case” sections match the status value (603 & 604), then the conversation engine proceeds to set the next “step” file, which may possibly be the same file if any of the actions did not indicate a change (606).

Set Next STEP (FIG. 7)

A step file is one of the system specification files that in part defines the local conversational domain that the conversation is centered on as defined above. When the conversation engine “sets” the next step it is shifting or in some cases refining the domain focus of the conversation.

After all of the actions have been executed then the conversation engine considers if a shift in the domain is required. This can be accomplished in two different ways. The first and generally most common way is to “go to” another step file. In the case of the “go to” the conversation engine's context of the current step is set to the step file directed by the “go to” (701). At that point at this point all of the new steps context and behaviors, as well as all of the context and behaviors of all of the steps it is derived from, are made active (702) and will be used in the processing of any received client generated structured messages.

If there is no directive to “go to” another step file in the conversation engine tests to see if another step file has been “called” (703). The concepts of “go to” and “called” are similar to those in conventional programming languages. Both of them specified transfer and control to another place in the system, but in this case when a step file is “called” there is the additional concept of returning to the original calling point in the conversation after the functionality that has been “called” has been completed. This calling mechanism may be nested as deeply as needed.

If the directive was to “call” another step in a reference to the currently active step file is put on a call stack (705) and the “called” step file is set as the new currently active step file and the processing loop continues waiting for the next structured message from the client (706).

If there was neither a “go to” or a “call” in the conversation engine remains in the same state and focused on the same step file (704). The next structured message received from the client will continue to be processed by this same step file.

Process Introduction Section (FIG. 8)

Upon entering a new step file (or reentering the same step file because no rules “fired” during the last turn) the introduction section of that step is processed and if necessary the actions and behaviors are combined with any actions and behaviors that were generated as a result of a previous rule “firing”. All of the individual and specific actions permitted within the action section of a rule are also allowed within the introduction section of any step.

If there are any actions to execute (801) in the introduction section, then process them (802). Otherwise, proceed to the adaptation phase.

All of the results of the previous actions from rule section and the introduction section are accumulated (803) and assembled into a single components that represent the speech, text, semantics, emotion, gesture, commands, graphic displays, media files to play, etc.

The resulting components are passed along for contextual adaptation.

Process Presentation Adaptation (FIG. 9)

Extract all the finalized and accumulated individual strings that represent components to be sent back to the client in a structured message (901).

In a process that can be done either in a loop or in a parallelized operation process each one individually in order to “adapt” them relative to the current context of the conversation.

For the purposes of this discussion we will describe the looped methodology. So, we will loop through the various result component types and within those component types we will loop through the individual character strings that represent those components. This function on the diagram is noted as “Get Next Component String” (902).

Does the string contain any curly brace expressions (they are of the form {xxx} and are described further in FIG. 11) (903). If not then test to see if there are more component strings and continue the search loop by getting the next component string if one exists.

If the string does contain a curly brace expression then process this string recursively replacing the curly brace sections with simple string values. The conversation engine does this replacement in conjunction with the conversation specification files and the collection of relevant states that are active at that point in the conversation (904).

If there are no more strings to the “adapted” then proceed to the next process (905).

Assemble Presentation and Attention Messages (FIG. 10)

Read all of the previously resolved simple strings from the presentation and commands section accumulators (1001). These are now all in their final form and format suitable for the client to use directly without any further processing.

Begin assembling the structured message to return to the client (1002). As mentioned earlier in this case we are using XML as the formalism to describe the process but the structured message can be any practical structured data exchange methodology. In this case the various strings that represent things such as text to display, or a semantic to display, or a media file to play, etc. are wrapped in their appropriate element tags and are grouped according to their categories such as presentation or commands. This results in a growing XML string that will ultimately contain all of the information to be transmitted to the client.

Next the attention section of the step file is extracted and processed (1003) to be transmitted to the client as a description of what the client should pay attention to (e.g. listen for speech, expect a tactile input, since device accelerations, etc.). Since even these attentional elements and directives are subject to contextual adaptation these attention section components are recursively evaluated to convert any of the curly brace objects into simple strings for the client to interpret (1004).

All the attention elements are assembled with their appropriate XML tags and added to the structured message being built and ready for transmission to the client (1005).

Process { } String Objects Recursively (FIG. 11)

Character strings in the conversation specification files are used to represent all of the input and output as well as the memory and logic of conversation as managed by the conversation engine. A list of the uses of the strings includes but is not limited to: prompts, semantic displays, names of information on the persistent structured conceptual memory, branching variables for conditional conversation flows, etc. The conversation engine supports a wide and extensible range of methods to render more abstract information into naturally varying and contextually relevant information. The conversation engine combines well-established techniques for abstract evaluation with more elaborate and novel techniques. It uses basic things such as simple retrieval of a variable from the systems persistent structured conceptual memory or even the retrieval of variable using levels of the referenced locations in the memory much like some computer languages permit a pointer to a pointer to a pointer etc. but ultimately points to a value. But it also adds more sophisticated concepts such as the elaboration of a named semantic into a character string that is generated in style and length at runtime to be appropriate and responsive to the user's expertise and mode of use at that particular conversational turn. Other sophisticated concepts it adds are the variable phrasing of simple semantics the variable (paraphrased) sentence structure of simple higher-level semantic utterances, and/or the ability to easily and automatically extract and include phrases and words used by the human in the course of the conversation. Much of the power of this { } processing comes from the ability to combine multiple { } in simple additive ways as well as in nested and recursive modes.

Prior to finalizing any string used in the conversation engine, that string is recursively evaluated for any {x:y:z} constructs and interpreted appropriately. This is done recursively because the evaluation of one { } object can lead to zero to many more { } objects. So the evaluation continues until no { } objects remain. Note there is an exception to this rule in that some { } objects can be as expressly designated for delayed evaluation.

So prior to being released as output or serialized and stored on the persistent memory the conversation engine tests whether it contains any { } objects (1101).

If the string does contain any { } objects then the conversation engine implements a depth first expansion of all the 0 objects as well as any 0 objects declared within the other { } objects. Note that nesting can be arbitrarily deep. After all of the depth first evaluation is done on the original string the new replacement string is tested again to see if any of those expansions led to the inclusion of more { } objects. If any { } objects remain the cycle continues until none are left (1102).

Time Context Awareness (FIG. 12)

At various times in a conversation the conversation engine can record human and system activities in a structured form on the persistent contextual system memory (1201). These recorded activities may be thought of as memories of specific events and they are explicitly “remembered” at points that are designated “memorable” by a conversation designer at specific points during the course of the conversation. In addition behind-the-scenes the conversation engine could unobtrusively “remember” when you visit specific locations (e.g. landmarks, places you've visited before, how many miles and/or minutes it took for each of your errands, etc.).

Specific events are remembered when the conversation designer specifies a <remember> action in any valid action section within a conversation specification file (see FIG. 6, action section). When the conversation engine encounters a <remember> action (1202) in the course of its operation it stores the high-level domain, focus, keyword information as well as automatically adds contextual information (1203) which includes but is not limited to the time associated with this memory, the location at the time the memory was recorded (coordinates and/or named locations), the name of the step file that defines how to talk about this memory at some point in the future, and optional hierarchical data node of structured data specific to this memory that the previously mentioned step file is designed to conversationally explore, etc.

An example of a <remember> action for buying some shoes at Macy's would look like this:

```
        <remember>
            <domain>purchase</domain>
            <focus>shoes</focus>
            <keywords>high heel,black</keywords>
            <context>
                <time>1340139771</time>
                <location>
                    <coord>40.750278, −73.988333</coord>
                    <name>Macy's</name>
                </location>
                <stepFile>storePurchaseMEM.step.xml</stepFile>
                data>
                    <!-- any amount of structured data that the step
file might use -->
                    <!-- e.g. Ferragomo, sling back, used coupon,
                    etc. -->
                </data>
            </context>
        </remember>
```

This “remembered” memory is put on a special place on the persistent contextual system memory. This mechanism permits the conversation engine to easily manage human queries about memories that the engine and the human have in common. This is done by using conversation specification files and methods described in elsewhere in this patent. For example:

Human: “Did I buy something last Tuesday?” (1204)

The rule that “fired” matches the above phrase to a semantic that means: search remembered items having the domain “purchase” that are time stamped anytime last Tuesday. (1205)

Engine: “Yes, Barbara. You bought some shoes at Macy's.”

The conversation engine finds that “remembered” data and can interject other information about the memory. (1206)

Human: “I forget, were they Gucci's?”

Since the conversation engine has also stored the fact that this “purchase” had a focus of “shoes”. And because this memory is associated with the conversation specification files that support a store purchase (e.g. storePurchaseMEM.step.xml) (1206). And because the conversation engine is aware of a range of shoe manufacturers either from the store catalog or from previous conversational experience with the human user, it can compare and either confirm or correct the human statement. (1207)

Engine: “No, they were Ferragamo's.”

Human: “Oh yeah, thanks.”

This method of remembering is not limited to any particular domain and one could easily imagine it being used to remind the human where they went to dinner last week, or when does a magazine subscription expire, where did they take that picture of Robert, etc.

FIG. 13

Automatically Update Grammars with Customer Data Feeds (FIG. 13)

One example of a use case for this conversational engine could be a product based conversation for a particular store. In that case in addition to generic conversational skills the conversation engine would need to understand the specific products and possibly some of the details of those products and the specific vocabulary used to talk about those products and details. So from the perspective of using speech input for this conversation and given the state of the art of speech recognition at this time one of the best ways to improve that recognition is to write a context free grammar that includes all of the specific terminology and its associated semantics.

While the overall approach would be much the same for any new domain that the conversation engine would address we will use the example of products from a specific store's catalog and explain the process of automatically generating an appropriate grammar that will improve the recognition and as a result the overall quality of the conversation.

The process begins with some sort of structured data feed in this example it is XML but as mentioned before it can be any agreed-upon structured data provided by the customers store (1101). When it is determined that the grammar needs to be created and/or updated a process on the conversation engine server can access the customer data feed and collect all of the relevant product information (1102).

After receiving the XML data it is parsed and prepared for data extraction (1103). Then the relevant data elements for this particular customers application are extracted from the various categories needed for the application (1104). The process will create a new grammar file unique to this customer and within that grammar file one or more rules (1105).

The rules created will represent categories for each of the important details extracted from the XML feed. For example an XML SRGS grammar rule containing a “one-of” element would contain a repeating list of SRGS “item” elements of all of the different product names retrieved from the data feed (1106). Additionally, a semantic value can be inserted into each product “item” element that may be a regularized version of the product name or perhaps the product identification number or any other appropriate unique value that the conversation engine could use to unambiguously identify what product the human meant precisely (1107).

Once the previously described rules are written to the file and saved then the main conversation engine's grammar is updated to reference this new customer's product grammar (1108). At this time a complete full grammar is regenerated (1109) and the updated grammar is transmitted to the speech recognizer server (1110).

The operation of the conversation engine is described in detail below.

Start Up Functions

* * *

Server Side:

The conversation engine 10 is started up with several command line arguments: the first argument is a file path to a place that contains the user or users conversation specification files, the second argument is the port number that the server will manage its conversation manager REST API interface, and the third argument specifies the communications protocol, which is usually HTTP, but which could be any acceptable protocol for exchanging XML strings.

The conversation manager server then initializes an array of individual conversation manager conversation engines, these engines wait in a dormant state for users to “logon” to their account. At such time and conversation manager engine instance is assigned to the user.

At this point the conversation manager server waits for a client logon.

Client Side:

The client sends an XML string to the conversation manager server that identifies the user and other ancillary information including but not limited to password, client device ID, software platform, on client TTS functionality, etc.

Server Side:

The server receives the string and uses the information to pair this user with one of the conversation manager conversation engine instances.

At the time when the engine and the user are paired the engine is given the location of that specific users conversation specification files.

The engine first looks in the configuration directory for that user and loads an XML “settings” file which contains numerous specific settings that govern the engine behavior for this particular user.

A nonexhaustive list of some of the specific settings are: debugging levels, logging levels, location of log files, recognition technologies to use, speech synthesis technologies to use, local and external application function services to connect with, the starting step file for the application, whether and where to log audio files, the location of other ancillary conversation specification files etc.

the “settings” file is passed to a “control” function.

The control function uses all the information in the “settings” file to restore this user's persistent memory and to load the other specification files which define the beginning stage of the application.

After everything is set up the control function extracts and prepares from the step files (and potentially other files) what will be presented to the user as the application starts up. This may include but is not limited to speech to be synthesized, semantics to be displayed, tables and/or images to be displayed, instructions to an avatar for gestures and or emotions, etc.

All of this presentation information is assembled into an XML string that is sent back over the network as a response to the specific users “logon”.

The server waits for the client side to transmit a user “turn”.

Client Side:

The client receives the XML string as a response to its request to logon.

The XML string is parsed into specific parameters. In those parameters are used to do specific things such as display text, initiate text-to-speech synthesis that will be played for the user, displaying other graphics which include but are not limited to tables, graphics, and images. Other specific parameters can be used to control a local avatar including but not limited to lip-synched speech, character emotional level, specific facial expressions, gestures, etc.

After the client presents all of this to the user it waits for some action by the user. This action by the user will represent the users “turn” in the conversation.

A “turn” can consist of any input that the client can perceive. It can be speech, mouse clicks, screen touches or gestures, voice verification, face identification, any sort of code scanning (e.g. barcodes), aural or visual emotion detection, device acceleration or orientation (e.g. tilting or tapping), location, temperature, ambient light, to name some but not all possible input modalities.

Once a “turn” action is detected (and locally processed if necessary) by the client it is encoded in an XML string and transmitted back to the conversation manager server.

Local processing includes but is not limited to gathering raw information on the device and manipulating it with a program on the device, or packaging the raw information in accordance with the input requirements for some external service which will manipulate the raw information and return some processed result that the client ultimately encodes in an XML string which is transmitted back to the conversation manager server.

Server Side:

The server instance that was paired with this particular user receives the XML string from the user's client.

This XML string is passed to a “converse” function.

The converse function parses the received XML string into specific parameters, one of which is a string that represents the users input action for this “turn”.

The operation of the “converse” function is described elsewhere in this patent, but at a high level of abstraction it combines the information from this turn, the remembered information from previous turns, other relevant information learned from previous experiences and encounters, user familiarity and practice at this point in the conversation, and other factors whose relevance is determined in a dynamic way.

During the course of its processing the “converse” function determines which rule in some “step” file will “fire”. Detailed specifications are under that rule is defined in the “step” file will be used to assemble a response XML string for the user and in addition to any other processing that is implicitly or explicitly required. This includes but is not limited to accessing the database to find data or search for patterns, collecting data from the Internet, modifying the interaction memory, sending commands to remote processes, generating visual and/or aural response directives, initiating and/or completing transactions (e.g. Purchases, banking), etc.

Once any or all of the above is completed the response XML string is transmitted to the client.

The server then waits for the next user “turn”.

Client/Server Loop:

This conversation continues in the indefinite loop between the client and the server via the exchange of XML strings.

The client constructs an XML string that represents the users “turn” and transmits it to the server. The server processes it in the “converse” function and generates a response XML string that is transmitted to the client.

The cycle continues until a specific command or event is interpreted by the server as a request to end this conversation. at that point the conversation manager engine saves all the relevant shared experience between the user and the engine. It then resets itself into a dormant state and waits for a new user to “logon”.

The “Converse” Function

* * *

Once a server session has been started via a user “logon” procedure the rest of the conversation is managed by repeatedly looping through the “converse” function.

The “converse” function consists of a single XML string for input and a single XML string for output. These are the strings that are exchanged between the server and client.

The most important parameter in the XML string coming from the client to the “converse” function is a simple character string

Step Files

* * *

The step file is an XML declarative formalism that defines and/or contains further definitions of how the conversation manager engine will behave when presented by a user's input “turn” and/or history of “turns”.

Top-Level Sections

* * *

### Head

introduction

* * *

This section contains actions to be accomplished upon entry to the step file. These actions use the same description language described elsewhere in this patent for the <action> elements within <rule> elements.

Attention

* * *

This section contains special instructions and reference data for specific technologies that are used to gather input such as speech, speaker verification, sensor inputs (e.g. GPS, accelerometers, temperature, images, video, scanners, etc.) and others.

Response

* * *

this section contains a group of rules and their declarations for how they are “fired” and what they subsequently do.

Rules

* * *

Rules contain a number of specific declarations that govern how the rule operates. These declarations are embodied in further elements and sub elements that I nested below each <rule> element.

<pattern>

this specifies the pattern that will cause this rule to “fire”. By default it uses the incoming utterance text from the client (or whatever text was transmitted as the result of some other modality e.g. “touched”, biometrics, etc.) and compares it to the pattern. Optionally it may set some other source of information to be used as the input source (e.g. something previously stored on the memory, or some other external input).

<branch>

the branch section contains multiple <case> sections which serve to refine the actions of a particular rule by selecting a further refinement of the behavior of the “fired” rule based on changes in data that happened during this rule firing or based on any other single or multiple conditions that are in the engine's historical record that might be used to modify the engine's response.

The <case> sections can contain any or all of the elements that a <rule> section can contain. When the engine determines that a particular <case> instant suitably matches its defined criteria then the various action, presentation, AFS function, etc. behaviors are processed and executed by the conversation manager engine.

<action>

this element contains a number of sub elements that define specific actions that are to be taken if this rule has “fired”. Some of the sub elements that are available below the action element are:

<setMEM>

this subsection allows one or more variables in the system memory to be set. It permits setting simple name value pairs as well as supporting more complex assignment of tree structures.

<function>

this subsection provides a method for calling one or more AFS functions (see the section in this patent called application function servers for more information about the sub elements, calling methods, and value returned structures).

<presentation>

this subsection contains information specific to the computer agent interaction with the user. The behaviors that it specifies include, but are not limited to, text for the text-to-speech engine to synthesize, text for the display page (readable text), the semantic that the engine believes was intended by the last user turn, an overall emotional state for the avatar to display or vocalize, a gesture that the avatar may display, etc.

<displayHTML>

this subsection supports transmitting engine generated HTML directly to a browser display. The transmitted HTML can be simple strings, or sections of the system memory (which can be thought of as XML), or an indirect reference to a section of the system memory (where the value for the source of the HTML is a variable and the value of that variable is used as the location on the system memory).

Evaluation and Expansion Modes

* * *

These are expressions of the form: {X:Y:Z} which can be used wherever character strings are used in the conversation manager language.

These expressions ultimately resolve to a single unambiguous character string.

These expressions may be nested to any depth and grouped to any arbitrary size required by the conversation design.

Production Grammars

MetaText

Extracting data from the conversation manager memory

Extracting semantics and related information

Extracting recognition rules and related information

Application Function Servers

As mentioned above one or more <AFS> elements may be present below the <function> element. These individual AFS functions are called in the order in which they appear under the <function> element.

The <AFS> element contains an attribute named “function”. The value of that attribute is represented as one or more character strings separated by a “period” character. After the attribute value has been parsed by the “period” characters the resulting components refer to a specific AFS module and secondly to the specific function within that AFS module that will be invoked, e.g. “someAFSModule.someFunctionInTheModule”. Additional components separated by additional “.” characters may be added if a specific AFS module/function

Examples of Uses:

This invention can be used in many ways. For example, the invention could be adapted to assist shoppers in finding products to buy, purchasing them, and remembering previous purchases. Another variation based on this invention could assist users in completing form filling applications such as insurance claim filing and review, medical billing assistance, inventory assistant for verticals in industry and public sector, and automating start-up and shut-down of complex systems. A third type of application based on this invention would be an application for elderly persons that assists them in remembering to take medications, medical appointments, and makes it easier for them to keep in touch with friends and family.

FIGS. 14A-L steps 1401-1472 illustrate how the system is used interactively by a user to generate a grocery shopping list. As previously discussed, information may be presented to a user either orally, or graphically using either text or images, e.g., of the articles on the list. Similarly, FIGS. 15A-15S steps 1501-1610 illustrate an interactive session between a user and the system used to buy a pair of ladies shoes.

These are just some of the uses that the invention could be used for. Obviously it could be extended to many other similar uses as well.

Numerous modifications may be made to the invention without departing from its scope as defined in the appended claims.

We claim:

1. A method of performing a task interactively with a user with a system including a dialog manager associated with a set of predefined processes for various activities, each activity including several steps, comprising:
receiving by the dialog manager a request from the user for particular activity;
identifying said activity as being one of the activities of said set by said dialog manager;
performing the steps associated with the identified activity; and
at the completion of said steps, presenting information derived from said steps to the user, said information being responsive to said request.

2. The method of claim 1 wherein said dialog manager is further associated with a set of external functions further comprising selecting by said dialog manager of one of said external functions based on said request and said activity, obtaining external information from the respective server and presenting said information to the user.

3. The method of claim 1 wherein said step of receiving the request includes receiving oral utterances from the user, further comprising analyzing said oral utterances by said dialog manager and selecting said activity based on said oral utterances.

4. The method of claim 1 further comprising providing information to the user by the dialog manager as one of an oral, text and graphic communication.

5. The method of claim 1 wherein said system includes an avatar generator further comprising presenting oral information to the user through said avatar generator.

6. An interactive method of performing a task for a user with a system including a dialog manager associated with a set of predefined interactive scripts, comprising:
receiving by the dialog manager a request from the user for a particular activity;
identifying an adaptive script from said set of scripts as being the script associated with the respective activity;
performing at least one function called for by said script; and
presenting information derived from said function to the user, said information being responsive to said request.

7. The method of claim 6 wherein said function is one of requesting more inputs from the user, invoking another script, obtaining information from a local source and invoking information from a remote source.

8. The method of claim 6 wherein said system is implemented on a server remote from the user.

9. The method of claim 6 wherein saud request is an oral request.

10. The method of claim 6 wherein said system includes a speech synthesizer and information is presented to the user orally through the synthesizer.

11. The method of claim 6 wherein said system further includes an avatar generator and information is presented to the user using an avatar generated by the avatar generator.

12. The method of claim 6 where is said adaptive script includes a plurality of steps, at least some of said steps include selecting an adaptive subscript based on information received during a previous step.

13. The method of claim 12 wherein said information is received from one of a user and a function performed by the system.

14. The method of claim 6 wherein said system includes an interface element providing interface to the Internet, and wherein based on said adaptive script. Information is obtained from remote sources by activating automatically a search engine by the script and collecting information from remote locations using said search engine.
